(19) United States
(12) Patent Application Publication
(10) Pub. No.: US 2013/0132672 A1
(43) Pub. Date: May 23, 2013

(54) OPTICAL DISK ARRAY DEVICE

(71) Applicants: Naohiro Kimura, Kyoto (JP); Yoshikazu Yamamoto, Osaka (JP); Motoshi Ito, Osaka (JP)

(72) Inventors: Naohiro Kimura, Kyoto (JP); Yoshikazu Yamamoto, Osaka (JP); Motoshi Ito, Osaka (JP)

(73) Assignee: PANASONIC CORPORATION, Osaka (JP)

(21) Appl. No.: 13/812,906

(22) PCT Filed: Jan. 11, 2012
(86) PCT No.: PCT/JP2012/000119

§ 371 Date: Jan. 29, 2013

(30) Foreign Application Priority Data
Jan. 12, 2011 (JP) 2011-003583
Jan. 18, 2011 (JP) 2011-007441

(51) Int. Cl. G06F 3/06

(52) U.S. Cl. CPC G06F 3/0689
USPC 711/114

(57) ABSTRACT

When RAID is constructed by using optical disks of the same lot, there is a problem in that the reproduction error probability of the RAID may have local increases over the reproduction error probability within the optical disks. According to the present invention, among a plurality of optical disks constituting an optical disk array, the smallest logical sector number is assigned to mutually different physical sector numbers. As a result, data in the same stripe is allowed to be recorded to sectors at mutually different physical sector numbers of the plurality of optical disks, so that the probability of occurrence of read errors due to interferences of adjacent guide grooves and/or insufficient formation of guide grooves can be leveled out, and the maximum probability of read errors can be kept small.

### TECHNICAL FIELD

The present invention relates to a data storage using a plurality of storage devices.

### BACKGROUND ART

In recent years, large amounts of data are coming to be stored on storage servers via networks. At storage servers, hard disks are generally used storage devices. Since a hard disk is a storage device which is relatively susceptible to malfunctioning, reliability of the stored data is ensured by constructing RAID (Redundant Arrays of Inexpensive Disks) imparted with redundancy. For example, RAID1, RAID5, and RAID6 are in use as redundancy-imparted constructions.

Moreover, in order to reduce any increase in energy consumption caused by the increasing amounts of stored data, there is a growing need for energy saving. In order to achieve these, storage servers which are capable of storing data with less energy are being desired. For example, optical disks are drawing attention as storage means that are capable of storing data with less energy than that for hard disks.

In an optical disk, errors may occur in the reproduced data owing to various stress factors, such as stress associated with the removable medium or stress associated with the fabrication process. Therefore, the recording data is protected by the use of powerful error correcting codes. Factors causing errors may be scratches or soil on the optical disk, quality at recording, degradation over time, and the like. Moreover, a recordable-type optical disk has meandering guide grooves and/or prepits previously formed thereon for rotation synchronization and address confirmation at data recording, and these may affect the RF signal and cause errors. For example, a method for reducing the influence of prepits is disclosed in Patent Document 1. Moreover, interferences of adjacent guide grooves and/or insufficient formation of guide grooves may also affect the RF signal.

### CITATION LIST

### Patent Literature

[Patent Document 1] Japanese Laid-Open Patent Publication No. 2002-32918
[Patent Document 2] Japanese Laid-Open Patent Publication No. 2002-93056
[Patent Document 3] Japanese Laid-Open Patent Publication No. 11-25574

### SUMMARY OF INVENTION

### Technical Problem

A disk array apparatus in which optical disks are used to construct RAID1 is described with reference to FIG. 1 and FIG. 2. FIG. 1 is a construction diagram of a disk array apparatus in which optical disks are used. The disk array apparatus 1006 includes a controller 1001, and drives 1002 and 1003. Optical disks 1004 and 1005 are mounted in the drives 1002 and 1003. The aggregate of optical disks 1004 and 1005 is referred to as a disk array.

Recording data from an external device (not shown) for the disk array apparatus 1006 is input to the controller 1001 together with logical addresses which are assigned in a user data space of the disk array. Herein, it is assumed that a logical address is assigned for every sector size that defines the smallest unit in a recording command for the drives 1002 and 1003. Generally speaking, the sector size is often selected to be 512 bytes for hard disks, and 2048 bytes for optical disks.

According to a predetermined relationship, the controller 1001 converts a logical address to a logical sector number which is assigned in the user data space of each optical disk. Then, to a drive corresponding to the optical disk 1004 or 1005, a recording command for the logical sector number into which the logical address has been converted is issued. When receiving the recording command from the controller 1001, in accordance with management information concerning positioning of regions of a mounted optical disk, the drive 1002 or 1003 converts the logical sector number into a physical sector number which uniquely represents a physical position on the optical disk. In an optical disk, error correcting coding is performed on a block-by-block basis, each block consisting of several sectors, this being in order to cope with relatively long pieces of soil, e.g., adhesion of fingerprints. Therefore, as necessary, the data of a corresponding block containing the sector of the physical sector number for recording is once reproduced, and the data of the sector at the corresponding physical sector number is altered and then the recording data is written back in a block-by-block manner, thus executing a record at the corresponding logical sector. This is a so-called read-modify-write operation. Note that a block often consists of 16 or 32 sectors.

In FIG. 2, the same range of physical sector numbers is assigned to the data area of each of the optical disk 1004 and the optical disk 1005. Hereinafter, an explanation will be offered by giving specific sector numbers and addresses, where any 0x at the beginning is an indication of a hexadecimal. RAID1, which is also called mirroring, records the same data to a plurality of storage devices. The controller 1001 adopts the intact value of the input logical address as the logical sector number for the optical disk 1004 and the optical disk 1005, and issues a recording command for both of the drive 1002 and the drive 1003. For example, as shown in FIG. 2, recording data A for a logical address 0x030000 is allocated to a logical sector number 0x030000, so as to be recorded at a sector of the physical sector number 0x060000 of the optical disk 1004 and at a sector of the physical sector number 0x060000 of the optical disk 1005. Moreover, recording data B for a logical address 0x200000 is allocated to a logical sector number 0x200000, so as to be recorded at a sector of the physical sector number 0x230000 of the optical disk 1004 and at a sector of the physical sector number 0x230000 of the optical disk 1005.

When constructing RAID, storage devices of the same capacity are generally to be used. Furthermore, in order to enhance the stability of the entire system, it is supposedly desirable that the storage devices used have the same degree of reliability (typically the same lot of the same product). When constructing RAID by using optical disks, it is supposedly desirable that those with the same degree of reliability (typically the same lot of the same product) are selected not only as the devices to be used, but also as the optical disks to be used in the respective devices.

In optical disks, a large amount of optical disks are produced from one stamper. Since the positions of guide grooves and/or prepits are determined by the stamper that is used in an injection molding machine, the guide grooves and/or prepits of any optical disks which are produced from the same stamper have entirely identical positions. In other words, between optical disks of the same lot, the positions of the previously-formed guide grooves and/or prepits are entirely identical. That is, in optical disks of the same lot, the same level of interferences of adjacent guide grooves and/or insufficient formation of guide grooves will exist at entirely identical positions.

However, since RAID has been devised for hard disks, in the aforementioned construction, data which is allocated to a predetermined logical address will be recorded at sectors of the same physical sector number on the two optical disks 1004 and 1005. For example, when optical disks which are liable to reproduction errors with an average probability of 1% are used, there is an average probability of 0.01% that data cannot be reproduced from a RAID1 that is constructed with the two storage devices. On the other hand, given a 1.5% probability of suffering from reproduction errors at places where errors are likely to occur due to interferences of adjacent guide grooves, the probability that any data that is recorded at such portions has reproduction errors will increase to 0.0225%. For example, assume that the sector of the physical sector number 0x060000 of the optical disk 1004 has an average reproduction error probability of 1%, and that the sector of the physical sector number 0x230000 has a reproduction error probability of 1.5%, which is 1.5 times the average, due to interferences of adjacent guide grooves. If the optical disks 1004 and 1005 are optical disks of the same lot, the reproduction error probability at the sector of the physical sector number 0x060000 of the optical disk 1005 is also 1%, and the reproduction error probability at the sector of the physical sector number 0x230000 is also 1.5%. As a result, while data A being allocated to the logical address 0x030000 has a reproduction error probability of 0.01%, data B being allocated to the logical address 0x200000 has an increased reproduction error probability of 0.0225%, which is more than twofold.

Thus, when RAID is constructed by using optical disks of the same lot, there is a problem in that the probability oscillation of reproduction errors within the optical disks is increased.

Next, a problem of the case where a RAID5 system is constructed with disk devices will be described.

FIG. 26 shows an example of a RAID5 system which is constructed with four disk devices. In RAID, the storage region of a disk device is kept under management while being divided into blocks of a size which is equal to the logical sector size or a multiple of the logical sector size. The size of a block is called the stripe size. In FIG. 26, blocks Ai, Bi, Ci, and Pi (i=1, 2, 3, . . . ) constitute one stripe. A block Pi is a parity block, where a result of calculating an exclusive OR of the data which are at the same byte position in the blocks Ai, Bi, and Ci is stored.

In RAID5, even when one disk device becomes unable to perform reproduction due to some problem, data restoration is still possible. For example, if a problem occurs in disk 3 in FIG. 26, making it unable to perform reproduction, block C1 can be restored by calculating an exclusive OR of the data at the byte position in blocks A1, B1, and P1.

Systems are also in use such that portable-medium type storage devices are employed in such a disk array apparatus. In a system where portable-medium type storage devices are used, a library device is employed that includes a cabinet in which a multitude of information storage media are accommodated, one or plural recording/reproduction devices which perform data read/write, and a carriage which carries a storage medium between the cabinet and the drive device. A system featuring an array structure combining a plurality of such library devices is also called RAIL (Redundant Arrays of Inexpensive Libraries).

In recent years, the amount of data that is stored in large-scale data centers is on a rapid increase, and consequently the amount of data which is not even frequently referred to tends to increase. As a device for archiving such data that is not frequently referred to, library devices of a portable medium type, which can reduce power consumption, are drawing attention.

Representative portable-type information storage media are optical disks such as the DVD (Digital Versatile Disc) and the Blu-ray Disc. In an optical disk, other than a user data region in which to store user data, a spare area is provided for allowing replacement recording of data in any defective region within the user data region. In order to reproduce or record data in the replacement-recorded region, the head needs to be moved to the spare area.

Moreover, there are optical disks having two or more recording layers, which require a focus jump upon switching between recording layers in order to focus on the recording layer in which data is to be next reproduced or recorded.

Furthermore, in order to reproduce or record data across a plurality of information storage media within a library device, it is necessary to change the information storage media in the middle of data reproduction/recording.

Thus, in portable-medium type library devices and array device of portable-medium type libraries, there may be points which do not allow continuous reproduction/recording of data, where data reproduction/recording may temporarily need to wait.

As to the spare area, a control method has been proposed which, while limiting a data read or write for the spare area, restores data from data that is reproduced from another information storage medium (see, for example, Patent Document 2).

Moreover, an apparatus has been proposed in which an extra recording/reproduction device and an extra information storage medium are provided, such that data reproduction/recording is performed on the extra information storage medium by using the extra recording/reproduction device during a period of changing information storage media (see, for example, Patent Document 3).

However, the above conventional control methods and apparatuses fail to give consideration to the time required for focus jumps upon switching between recording layers of an information storage medium having two or more recording layers, thus resulting in a problem in that data reproduction/recording temporarily needs to wait when switching between recording layers.

Moreover, the need to provide an extra recording/reproduction device and an extra information storage medium in order to continue data reproduction/recording when changing information storage media requires a complicated construction. A construction having an extra recording/reproduction device also has a problem in that, since only the recording/reproduction devices excluding the extra recording/reproduction device are used at normal times, the performance relative to the number of recording/reproduction devices is poorer.

The present invention has been made in view of the above problems, and provides an optical disk array apparatus which ensures reliability of stored data. Moreover, the present invention provides an optical disk array apparatus which can continuously perform data reproduction even upon switching between recording layers of an optical disk or when changing optical disks, without using any extra recording/reproduction devices.

### Solution to Problem

An optical disk array apparatus according to the present invention is an optical disk array apparatus having a plurality of recording/reproduction devices for performing data recording and reproduction on an optical disk, the optical disk array apparatus comprising an assignment section for assigning a smallest logical sector number of an optical disk mounted in one of the plurality of recording/reproduction devices to a physical sector number that is different from a physical sector number to which a smallest logical sector number of an optical disk mounted in at least one of the other recording/reproduction devices is assigned.

In one embodiment, the assignment section assigns smallest logical sector numbers of the respective optical disks mounted in the plurality of recording/reproduction devices to mutually different physical sector numbers.

One embodiment further comprises a determination section for determining stampers used for producing the respective optical disks mounted in the plurality of recording/reproduction devices, wherein the assignment section assigns smallest logical sector numbers of optical disk sharing a same stamper to mutually different physical sector numbers.

In one embodiment, each optical disk includes a data area and a spare area; and the assignment section assigns a respectively different size for the spare area which is at a leading end of the data area of each optical disk.

In one embodiment, the assignment section ensures a size assignment so that a total of a size of the spare area at the leading end of the data area and a size of the spare area at a trailing end of the data area is mutually equal among the plurality of optical disks.

In one embodiment, each optical disk includes a data area; and in an optical disk whose smallest logical sector number is assigned to a physical sector number not corresponding to a leading end of the data area, the assignment section allows a next logical sector number to a logical sector number which is assigned to a physical sector number corresponding to a trailing end of the data area to be assigned to a physical sector number corresponding to the leading end of the data area.

An optical disk array apparatus according to the present invention is an optical disk array apparatus for reproducing data from optical disks, the optical disk array apparatus comprising a plurality of optical disk library devices each including a recording/reproduction device, a cabinet, and a carriage, the cabinet accommodating a plurality of optical disks, and the optical disk being carried by the carriage between the cabinet and the recording/reproduction device for permitting data reproduction by the recording/reproduction device, wherein, a disk array is constituted by the plurality of optical disks in the plurality of optical disk library devices; stripes are recorded in the disk array; the stripes have redundancy for enabling, when data fails to be reproduced in at least one of the plurality of optical disks in which data composing a same stripe is recorded, restoration of the data failing to be reproduced; data composing a same stripe is recorded at physically different positions of the plurality of optical disks, so that mutually different timings for optical disk changing exist among the plurality of optical disk library devices; the optical disk library device avoids reproducing data in a predetermined region range immediately after optical disk changing; and the data in the predetermined region range is restored from data reproduced by the optical disk library devices other than the optical disk library device avoiding data reproduction in the predetermined region range.

In one embodiment, the optical disk library device avoiding data reproduction in the predetermined region range performs the optical disk changing while restoring the data.

In one embodiment, each of the plurality of optical disks has a plurality of recording layers; data composing a same stripe is recorded at physically different positions of the plurality of optical disks, so that mutually different timings for recording layer switching exist among the plurality of optical disk library devices; the optical disk library device avoids reproducing data in a predetermined region range immediately after recording layer switching; and the data in the predetermined region range immediately after recording layer switching is restored from data reproduced by the optical disk library devices other than the optical disk library device avoiding data reproduction in the predetermined region range immediately after recording layer switching.

In one embodiment, while the data is being restored, the optical disk library device avoiding data reproduction in the predetermined region range immediately after recording layer switching switches recording layers and prepares itself to reproduce data in a subsequent region of the predetermined region range.

In one embodiment, the optical disks have a leading spare area and a trailing spare area; and data composing a same stripe is recorded at physically different positions of the plurality of optical disks by varying a ratio between sizes of the leading spare area and the trailing spare area among the plurality of optical disks constituting the disk array.

A reproduction method according to the present invention is a reproduction method for reproducing data from a disk array composed of a plurality of optical disks, wherein, stripes are recorded in the disk array; the stripes have redundancy for enabling, when data fails to be reproduced in at least one of the plurality of optical disks in which data composing a same stripe is recorded, restoration of the data failing to be reproduced; data composing a same stripe is recorded at physically different positions of the plurality of optical disks; and each optical disk composing the disk array is changeable to another optical disk, the reproduction method comprising: a step of avoiding data reproduction in a predetermined region range immediately after optical disk changing; and a step of restoring the data in the predetermined region range from data which is reproduced from the remaining optical disks composing the disk array excluding an optical disk in which data reproduction in the predetermined region range is avoided.

### Advantageous Effects of Invention

According to the present invention, the smallest logical sector number of an optical disk is assigned to a physical sector number that is different from a physical sector number to which the smallest logical sector number of at least another optical disk is assigned. As a result, data in the same stripe is allowed to be recorded to sectors at mutually different physical sector numbers of the plurality of optical disks. As used herein, a stripe is a unit by which data can be restored with redundancy. In RAID1, a stripe is a smallest structural unit by which the same data can be independently recorded or reproduced. In RAID4 or RAID5, a striped is a smallest structural unit composed of a group of data which can be independently recorded or reproduced and a parity thereof. With the above features, the probability of occurrence of read errors due to interferences of adjacent guide grooves and/or insufficient formation of guide grooves can be leveled out, and the maximum probability of read errors can be kept small.

Moreover, according to the present invention, even upon switching between recording layers or when changing optical disks, it is possible to continuously reproduce data without having to wait.

### BRIEF DESCRIPTION OF DRAWINGS

FIG. 1 A construction diagram of a disk array apparatus in which optical disks are used.

FIG. 2 A diagram showing data recording positions in RAID1.

FIG. 3 A diagram showing the format of an optical disk according to Embodiment 1 of the present invention.

FIG. 4 A diagram showing the format of a data zone according to Embodiment 1 of the present invention.

FIG. 5 A block diagram showing the construction of an optical disk array apparatus according to Embodiment 1 of the present invention.

FIG. 6 (a) to (d) are diagrams showing allocation of inner spare areas according to Embodiment 1 of the present invention.

FIGS. 7 (a) and (b) are diagrams showing a stripe construction and assignment of logical addresses and logical sector numbers according to Embodiment 1 of the present invention.

FIG. 8 (a) to (d) are diagrams showing assignment of logical sector numbers and physical sector numbers according to Embodiment 1 of the present invention.

FIG. 9 A diagram showing positioning of stripe data according to Embodiment 1 of the present invention.

FIG. 10 (a) to (d) are diagrams showing allocation of inner spare areas according to Embodiment 2 of the present invention.

FIG. 11 A block diagram showing the construction of an optical disk array apparatus according to Embodiment 3 of the present invention.

FIG. 12 (a) to (d) are diagrams assignment of physical sector numbers for the logical sector number 0x000000 according to Embodiment 3 of the present invention.

FIG. 13 (a) to (d) are diagrams showing assignment of logical sector numbers and physical sector numbers according to Embodiment 3 of the present invention.

FIG. 14 A diagram showing positioning of stripe data according to Embodiment 3 of the present invention.

FIG. 15 A diagram showing the construction of an information storage medium library array apparatus according to Embodiment 4 of the present invention.

FIG. 16 A diagram showing data positioning of an information storage medium according to Embodiment 4 of the present invention.

FIG. 17 A diagram showing a state of stripes near switching between recording layers of information storage media according to Embodiment 4 of the present invention.

FIG. 18 A diagram showing data positioning of an information storage medium having spare areas according to Embodiment 4 of the present invention.

FIG. 19 A flowchart showing a reproduction operation according to Embodiment 4 of the present invention.

FIG. 20 A diagram showing data positioning of information storage medium sets according to Embodiment 5 of the present invention.

FIG. 21 A diagram showing a state of stripes in regions that are reproduced before or after changes of the information storage media in information storage medium sets according to Embodiment 5 of the present invention.

FIG. 22 A flowchart showing a reproduction operation according to Embodiment 5 of the present invention.

FIG. 23 A diagram showing data positioning of information storage medium sets according to Embodiment 6 of the present invention.

FIG. 24 A flowchart showing a reproduction operation according to Embodiment 6 of the present invention.

FIG. 25 A diagram showing an example data positioning of information storage medium sets having spare areas according to Embodiment 6 of the present invention.

FIG. 26 A diagram showing an exemplary construction of a RAID5 system.

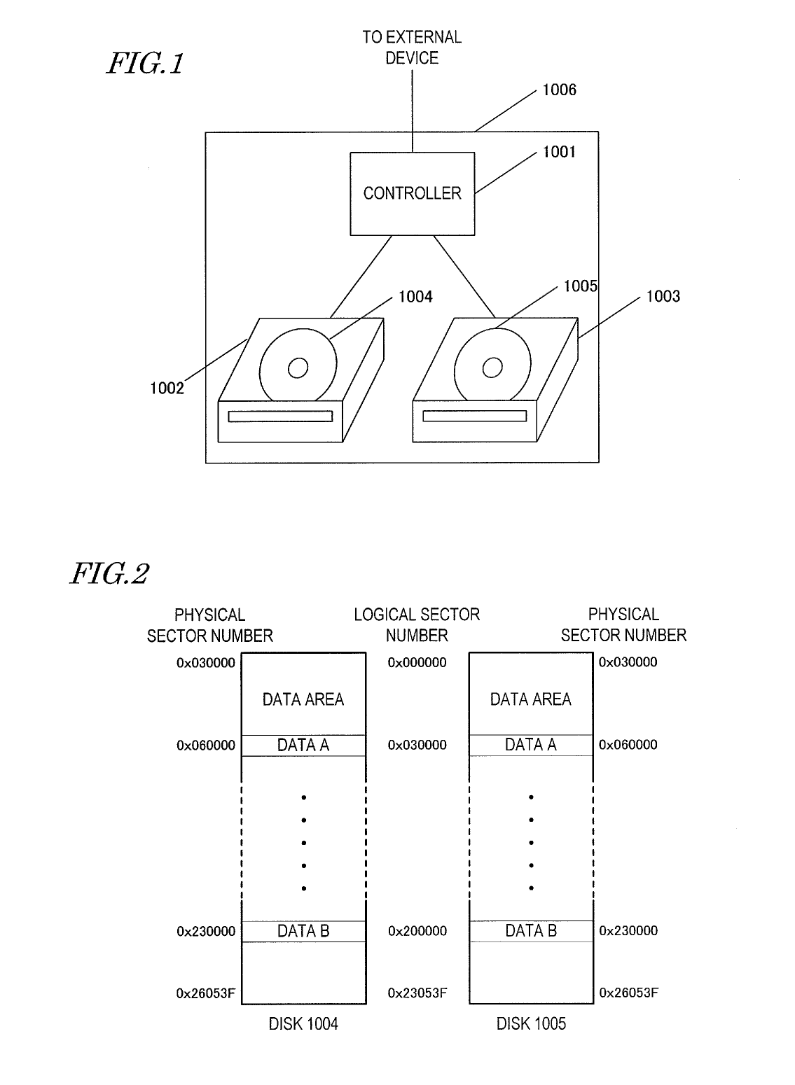

### DESCRIPTION OF EMBODIMENTS

Hereinafter, embodiments of the present invention will be described with reference to the drawings.

### Embodiment 1

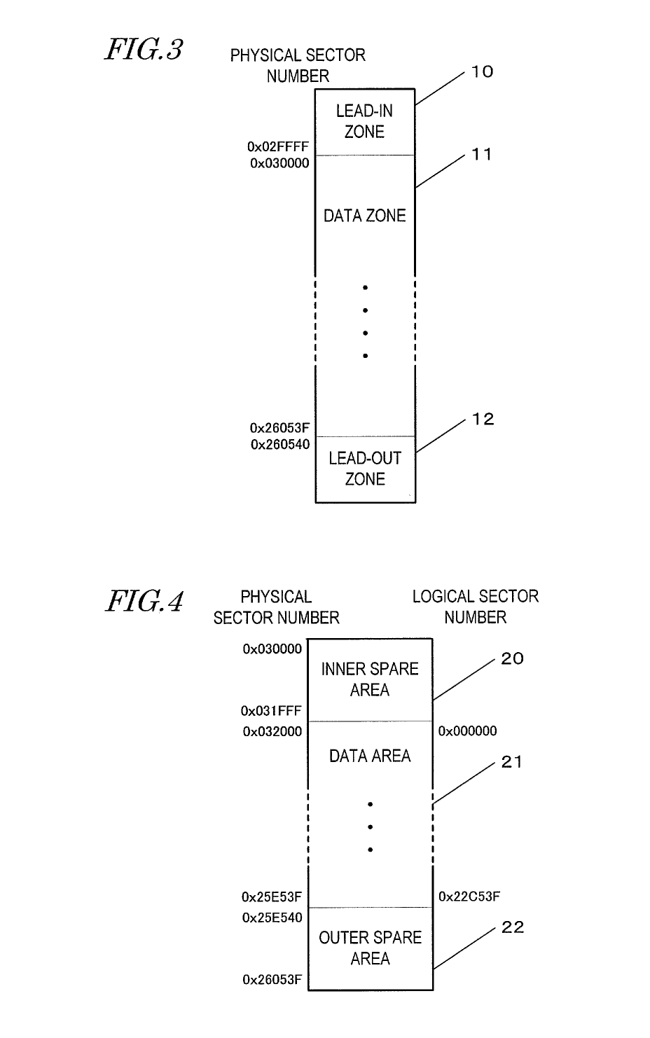

FIG. 3 is a diagram for describing the format of an optical disk according to Embodiment 1 of the present invention. The optical disk includes a lead-in zone 10, a data zone 11, and a lead-out zone 12. FIG. 4 is a diagram for describing the format of the data zone 11 according to Embodiment 1 of the present invention. The data zone 11 includes an inner spare area 20, a data area 21, and an outer spare area 22. The inner spare area 20 is exemplary of a spare area that is located closer to the leading end than is the data area 21 along the direction of track recording/reproduction. The outer spare area 22 is exemplary of a spare area that is located closer to the trailing end than is the data area 21 along the direction of track recording/reproduction.

The lead-in zone 10 includes test areas for performing tests at production of the optical disk and upon recording in a drive, a management area in which to record management information concerning the format of the data zone 11, and the like. User data is to be recorded in the data zone 11. Similarly to the lead-in zone 10, the lead-out zone also includes test areas for performing tests at production of the optical disk and upon recording in a drive, and so on.

In the case of an optical disk which supports replacement recording, the data zone 11 is further divided into the inner spare area 20, the data area 21, and an outer data area 22. For example, the inner spare area 20 is allocated to sectors of physical sector numbers 0x030000 to 0x031FFF. The data area 21 is allocated to sectors of physical sector numbers 0x032000 to 0x25E53F. The outer spare area 22 is allocated to sectors of physical sector numbers 0x25E540 to 0x26053F.

User data is recorded in the data area 21. Generally, logical sector numbers beginning from 0x000000 are consecutively assigned from the leading end of the data area 21. Such assignments are part of the management information, and recorded in a management information area within the lead-in zone 10.

If a recording to the data area 21 fails, the data whose recording has failed is replacement-recorded to the inner spare area 20 or the outer spare area 22. For example, if a recording to a sector of the physical sector number 0x033000, which is assigned to the logical sector number 0x001000, fails, then a sector of an unused physical sector number (e.g., 0x030000) is selected from the inner spare area 20, and the data allocated to the logical sector number 0x001000 is recorded to the sector of the physical sector number 0x030000. Furthermore, the fact that the data to have been recorded to the sector of the physical sector number 0x033000 is replacement-recorded to the sector of the physical sector number 0x030000 is recorded, as management information, in the lead-in zone 10.

A replacement recording may also be performed in cases other than a failure in recording. For example, it may be performed when, upon trying to read from a recorded portion immediately after the recording, the read does not occur correctly. Moreover, a replacement recording may be performed when a predetermined number of errors or more exist when a recorded portion is read, or when a measured value of recording quality is poorer than a predetermined value.

Next, an optical disk array apparatus according to Embodiment 1 of the present invention will be described with reference to FIG. 5. FIG. 5 is a block diagram showing the construction of an optical disk array apparatus 35 according to Embodiment 1 of the present invention. The optical disk array apparatus 35 includes a controller 30 and drives 31 to 34. Optical disks 36 to 39 are mounted in the drives 31 to 34. The aggregate of optical disks 36 to 39 will be referred to as an optical disk array.

The optical disk array apparatus 35 is connected to an external device (not shown) via the controller 30, so that the whole functions as RAID4. For any recording data which is input from the external device, the controller 30 determines, on the basis of a logical address, a drive and a logical sector number to which it is to be recorded, and issues a recording command to the corresponding drive 31 to 33. Furthermore, a recording command for parity data, which is generated from the recording data that is input from the external device, is issued to the drive 34. In accordance with the recording commands from the controller 30, the drives 31 to 34 record the recording data and the parity data to the mounted optical disks 36 to 39.

Moreover, before a first recording is performed for the mounted optical disks 36 to 39, the drives 31 to 34 format the optical disks to allocate the inner spare area 20, the data area 21, and the outer spare area 22. Prior to formatting, the controller 30 designates respectively different sizes of inner spare areas 20 to the drives 31 to 34.

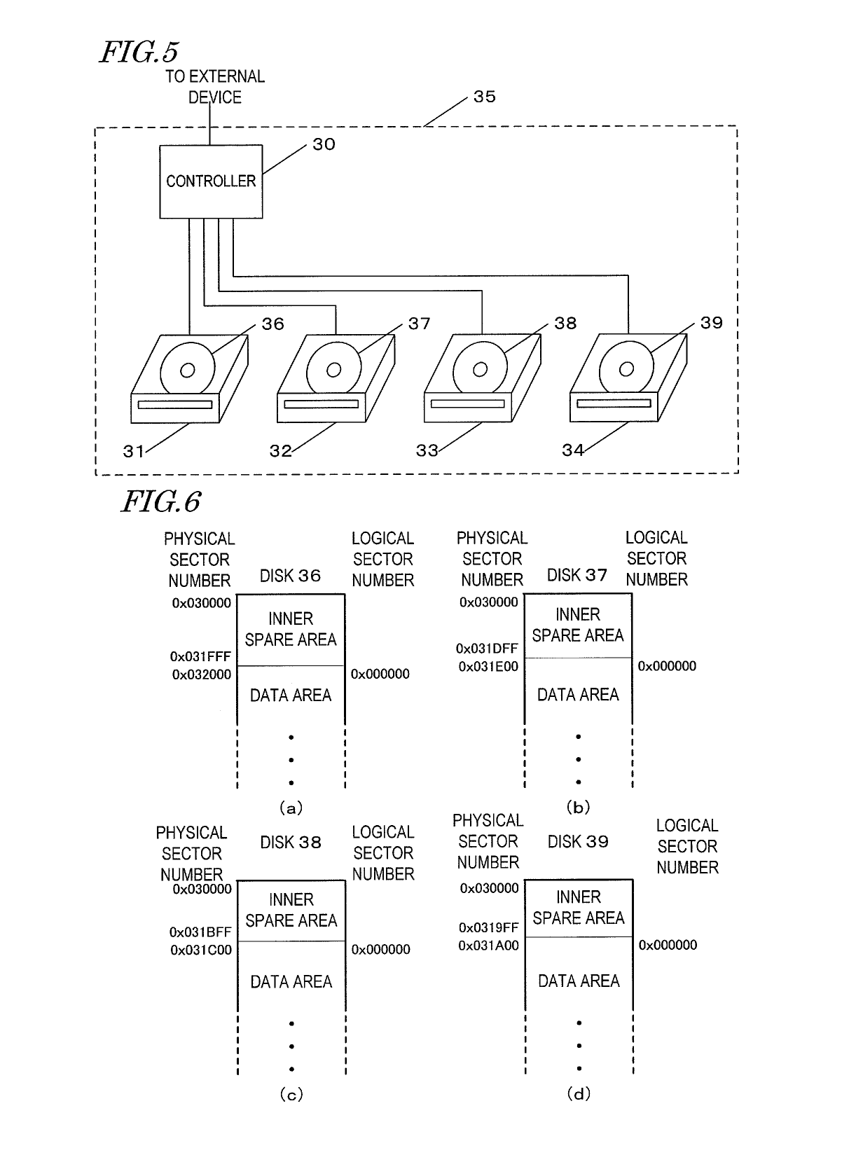

An example thereof will be described with reference to FIG. 6. FIG. 6 is a diagram showing allocation of inner spare areas 20 according to Embodiment 1 of the present invention. In accordance with an instruction from the controller 30, the drive 31 allocates sectors of the physical sector numbers 0x030000 to 0x031FFF of the optical disk 36 as the inner spare area 20, as shown in FIG. 6(a). As shown in FIG. 6(b), the drive 32 allocates sectors of the physical sector numbers 0x030000 to 0x031DFF of the optical disk 37 as the inner spare area 20. As shown in FIG. 6(c), the drive 33 allocates sectors of the physical sector numbers 0x030000 to 0x031BFF of the optical disk 38 as the inner spare area 20. As shown in FIG. 6(d), the drive 34 allocates sectors of the physical sector numbers 0x030000 to 0x0319FF of the optical disk 39 as the inner spare area 20.

Thus, respectively different sizes are allocated for the spare areas of the optical disks 36 to 39.

Moreover, as shown in FIG. 6, the smallest logical sector number, i.e., the logical sector number 0x000000, is assigned to mutually different physical sector numbers in the optical disks 36 to 39.

Specifically, in the optical disk 36, the smallest logical sector number, i.e., the logical sector number 0x000000, is assigned to the physical sector number 0x032000. In the optical disk 37, the smallest logical sector number, i.e., the logical sector number 0x000000, is assigned to the physical sector number 0x031E00. In the optical disk 38, the smallest logical sector number, i.e., the logical sector number 0x000000, is assigned to the physical sector number 0x031C00. In the optical disk 39, the smallest logical sector number, i.e., the logical sector number 0x000000, is assigned to the physical sector number 0x031A00.

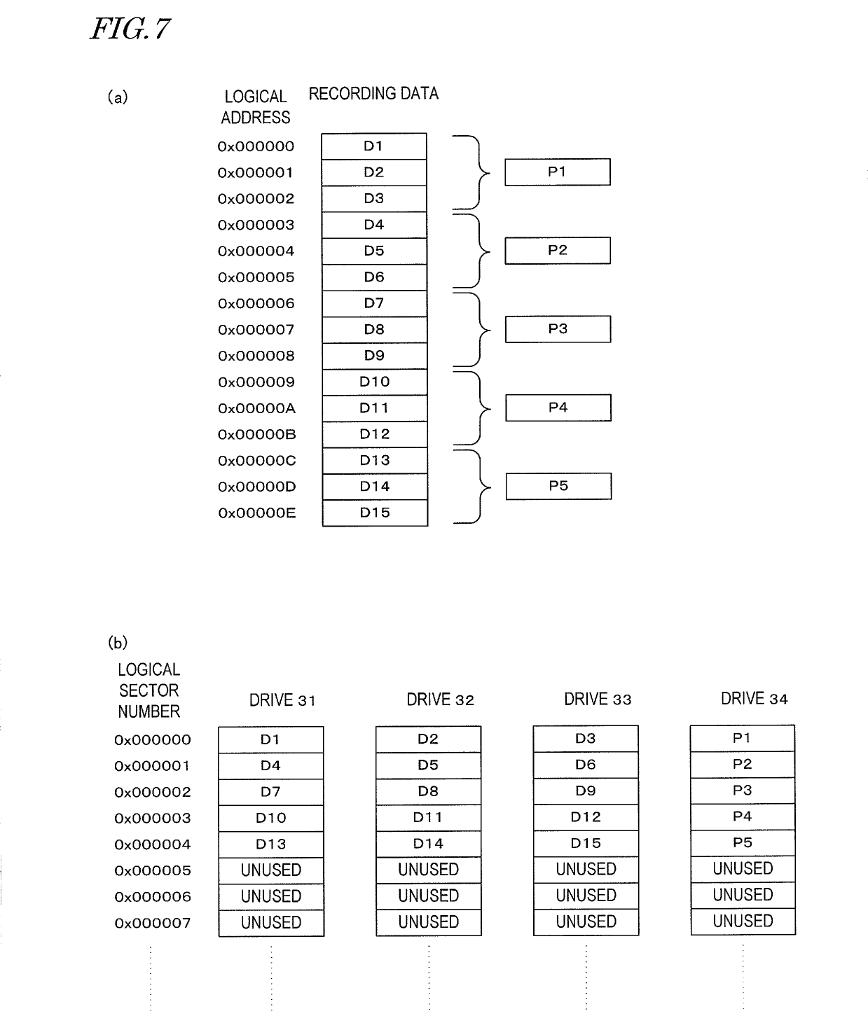

Next, with reference to FIG. 7, a stripe construction and assignment of logical addresses and logical sector numbers will be described. As used herein, a stripe is a unit by which data can be restored with redundancy. In RAID1, a stripe is a smallest structural unit by which the same data can be independently recorded or reproduced. In RAID4 or RAID5, a stripe is a smallest structural unit composed of a group of data which can be independently recorded or reproduced and a parity thereof.

FIGS. 7(a) and (b) are diagrams showing a stripe construction and assignment of logical addresses and logical sector numbers according to Embodiment 1 of the present invention. Recording data D1 to D15 for logical addresses 0x000000 to 0x00000E of the optical disk array are input from the external device to the controller 30. The controller 30 generates a parity P1 from D1 to D3, a parity P2 from D4 to D6, a parity P3 from D7 to D9, a parity P4 from D10 to D12, and a parity P5 from D13 to D15. As a result, five stripes (D1 to D3, P1), (D4 to D6, P2), (D7 to D9, P3), (D10 to D12, P4), (D13 to D15, P5) are made.

The controller 30 allocates the recording data D1 to D15 and the parity data P1 to P5 to logical sector numbers of the optical disks 36 to 39 in such a manner that the data composing the same stripe will be recorded on respectively different optical disks, and issues a recording command to the drives 31 to 34. The recording data D1, D4, D7, D10, and D13 are allocated to logical sector numbers 0x000000 to 0x000004 of the optical disk 36, and transferred to the drive 31. The recording data D2, D5, D8, D11, and D14 are allocated to logical sector numbers 0x000000 to 0x000004 of the optical disk 37, and transferred to the drive 32. The recording data D3, D6, D9, D12, and D15 are allocated to logical sector numbers 0x000000 to 0x000004 of the optical disk 38, and transferred to the drive 33. The parity data P1, P2, P3, P4, and P5 are allocated to logical sector numbers 0x000000 to 0x000004 of the optical disk 39, and transferred to the drive 34.

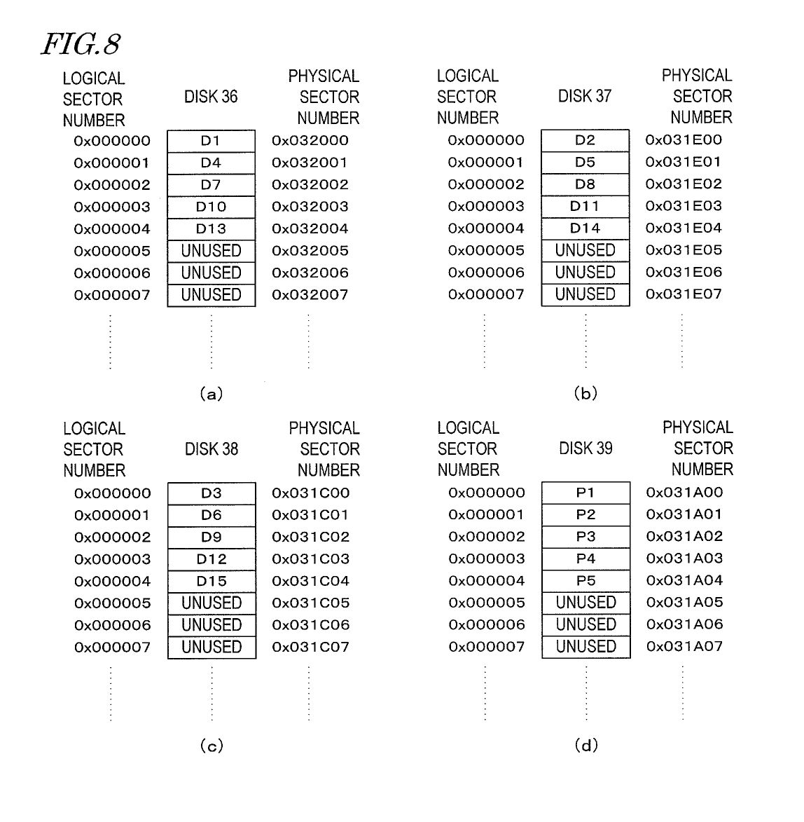

The relationship between the logical sector numbers which are assigned to recording data and parity data and the physical sector numbers at which such data are actually recorded will be described with reference to FIG. 8. FIG. 8 is a diagram of assignment of logical sector numbers and physical sector numbers according to Embodiment 1 of the present invention.

The recording data D1 is recorded at a sector of the physical sector number 0x032000 of the optical disk 36. The recording data D2 is recorded at a sector of the physical sector number 0x031E00 of the optical disk 37. The recording data D3 is recorded at a sector of the physical sector number 0x031C00 of the optical disk 38. The recording data D4 is recorded at a sector of the physical sector number 0x032001 of the optical disk 36. The recording data D5 is recorded at a sector of the physical sector number 0x031E01 of the optical disk 37. The recording data D6 is recorded at a sector of the physical sector number 0x031C01 of the optical disk 38. The recording data D7 is recorded at a sector of the physical sector number 0x032002 of the optical disk 36. The recording data D8 is recorded at a sector of the physical sector number 0x031E02 of the optical disk 37. The recording data D9 is recorded at a sector of the physical sector number 0x031C02 of the optical disk 38. The recording data D10 is recorded at a sector of the physical sector number 0x032003 of the optical disk 36. The recording data D11 is recorded at a sector of the physical sector number 0x031E03 of the optical disk 37. The recording data D12 is recorded at a sector of the physical sector number 0x031C03 of the optical disk 38. The recording data D13 is recorded at a sector of the physical sector number 0x032004 of the optical disk 36. The recording data D14 is recorded at a sector of the physical sector number 0x031504 of the optical disk 37. The recording data D15 is recorded at a sector of the physical sector number 0x031C04 of the optical disk 38. The parity data P1 is recorded at a sector of the physical sector number 0x031A00 of the optical disk 39. The parity data P2 is recorded at a sector of the physical sector number 0x031A01 of the optical disk 39. The parity data P3 is recorded at a sector of the physical sector number 0x031A02 of the optical disk 39. The parity data P4 is recorded at a sector of the physical sector number 0x031A03 of the optical disk 39. The parity data P5 is recorded at a sector of the physical sector number 0x031A04 of the optical disk 39.

Since the recording data which are recorded in this manner constitute RAID4, even if one piece of recording data in the same stripe becomes unable to read, it can be restored from the other recording data and the parity data in that stripe. For example, if D3 becomes unable to read, D3 can be determined and restored through calculation from the other recording data and the parity data (D1, D2, P1) in the stripe that contains D3.

As described above, the optical disk array apparatus of the present embodiment includes a plurality of recording/reproduction devices (drives) which record and reproduce data on optical disks. Moreover, the optical disk array apparatus of the present embodiment includes an assignment section (controller 30). In this state, for the respective optical disks mounted in the recording/reproduction devices, the assignment section assigns the smallest logical sector number of each optical disk to a respectively different physical sector number.

Furthermore, in the present embodiment, each optical disk may include a data area and a spare area. In this case, the assignment section of the optical disk array apparatus may allocate a respectively different size for the spare area (inner spare area) located at the leading end of the data area of each optical disk.

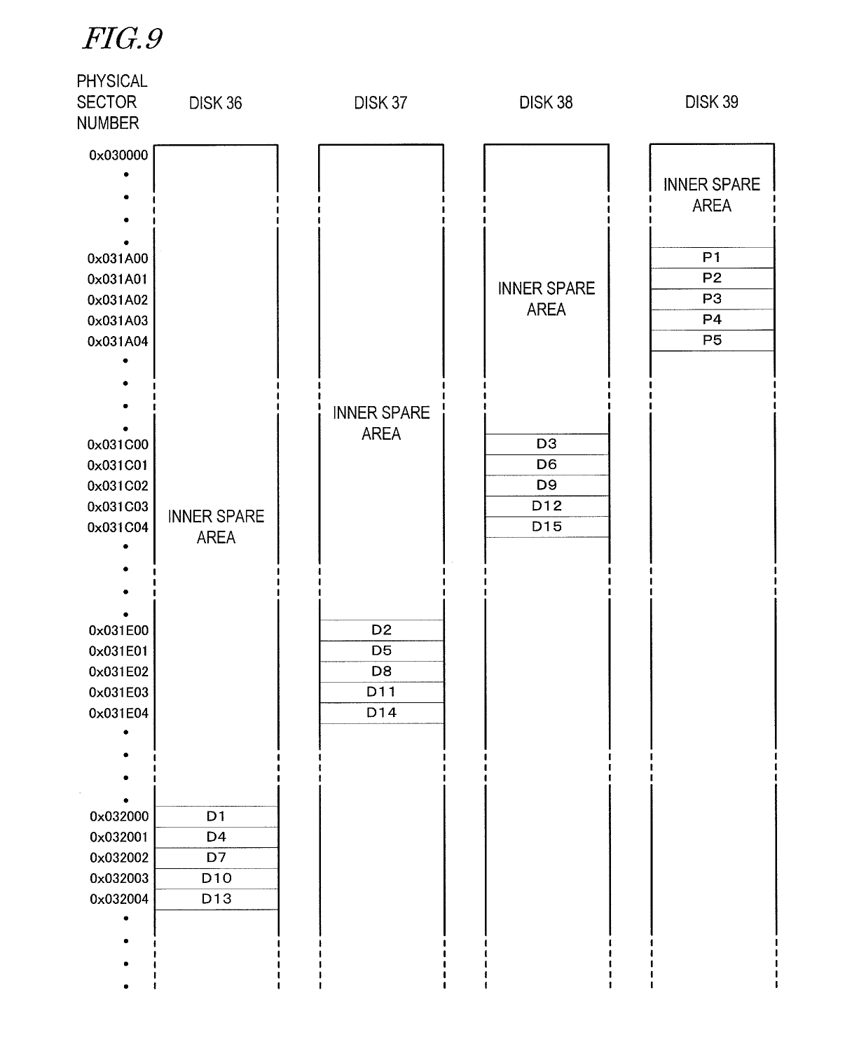

By ensuring a respectively different size of the inner spare area 20 of each optical disk composing the optical disk array, as shown in FIG. 9, data belonging to the same stripe is recorded at sectors of mutually different physical sector numbers of the respective optical disks. As a result, the probability of occurrence of read errors due to interferences of adjacent guide grooves and/or insufficient formation of guide grooves can be leveled out, and the maximum probability of read errors can be kept small.

Although it is illustrated that the size of the inner spare area 20 is designated by the controller 30 to the drives 31 to 34 in advance, the drives 31 to 34 may themselves determine respectively different predetermined sizes. In other words, although the present embodiment illustrates the assignment section as being the controller 30, the drives 31 to 34 themselves may each include its own assignment section.

Note that formatting of the optical disks may be executed when a command to initialize the optical disk array comes from an external device.

The present embodiment illustrates an example where, in all of the optical disks 36 to 39, the smallest logical sector number is assigned to respectively different physical sector numbers. It also illustrates an example where, in all of the optical disks 36 to 39, respectively different sizes are allocated to their spare areas (inner spare areas) located at the leading end of each data area. However, the construction of the present embodiment is not limited thereto.

For example, only the smallest logical sector number of the optical disk that is mounted in one predetermined drive among the plurality of drives may be assigned to a different physical sector number from the physical sector number to which the smallest logical sector number of another optical disk mounted in any drive other than the predetermined drive is assigned.

Similarly, to only the spare area (inner spare area) located at the leading end of the data area of the optical disk that is mounted in one predetermined drive among the plurality of drives, a different size from the size of the spare area (inner spare area) located at the leading end of the data area of another optical disk mounted in any drive other than the predetermined drive may be allocated.

This is not limited to there being only one such drive and optical disk. Specifically, when the optical disk array apparatus includes N (which is an integer such that N) drives, in those optical disks which are mounted in M (which is an integer such that 1≦M≦N) drives among the N drives, the smallest logical sector number of each may be assigned to a different physical sector number from a physical sector number to which the smallest logical sector number of another optical disk mounted in any other drive is assigned.

Similarly, to the spare area (inner spare area) located at the leading end of the data area of each of those optical disks mounted in M drives, a different size from the size of the spare area (inner spare area) located at the leading end of the data area of another optical disk mounted in any other drive may be allocated.

However, in the case where N is such that 3≦N and M is such that 1≦M≦N among the optical disks mounted in the N drives, there may be a combination(s) of optical disks in which the smallest logical sector number is assigned to the same physical sector number as one another. Similarly, among the optical disks mounted in the N drives, there may be a combination(s) of optical disks the sizes of whose spare areas (inner spare areas) located at the leading end of each data area are designated to be the same size as one another.

However, in such cases, too, in the optical disk(s) mounted in at least one drive among the N drives, data in the same stripe can be recorded at a sector of a different physical sector number.

Therefore, increase in the aforementioned probability oscillation of reproduction errors is reduced in the present invention, as compared to any construction in which data in the same stripe is recorded to sectors of the same physical sector number in all of a plurality of optical disks. In other words, data reliability can be enhanced.

It is preferable that, as was mainly so described in the present embodiment, the smallest logical sector number is assigned to mutually different physical sector numbers among the optical disks mounted in all drives (i.e., M=N).

Similarly, preferably among the optical disks mounted in all drives (i.e., M=N), respectively different sizes are allocated to the spare areas (inner spare areas) located at the leading end of each data area.

As a result, in all of the optical disks mounted in the plurality of drives, data in the same stripe can be recorded to sectors of different physical sector numbers. Therefore, the increase in the aforementioned probability oscillation of reproduction errors can be reduced to the largest degree. In other words, data reliability can be enhanced.

### Embodiment 2

A case will be described where, in the construction of Embodiment 1 described above, the optical disk 36 and the optical disk 37 are of the same lot manufactured by company A, while the optical disk 38 and the optical disk 39 are of the same lot manufactured by company B.

When receiving from an external device a command to initialize the optical disk array, the controller 30 issues a command to acquire disk information to the drives 36 to 39, and acquires manufacturer numbers and revision numbers of the optical disks 36 to 39. Based on the acquired manufacturer numbers and revision numbers, the controller 30 designates sizes of inner spare areas 20 of the optical disks 36 to 39 for the drives 31 to 34. The drives 31 to 34 format the optical disks 36 to 39 so that the sizes of their inner spare areas 20 are sizes as designated by the controller 30.

It is assumed herein that the optical disk 36 and the optical disk 37 are of the same manufacturer number and the same revision number, and that the optical disk 38 and the optical disk 39 are of the same manufacturer number and the same revision number, which are different from those of the optical disk 36. The controller 30 identifies the optical disk 36 and the optical disk 37, which have matching manufacturer numbers and revision numbers, as optical disks of the same lot (i.e., optical disks which were produced with the same stamper), and designates respectively different sizes of inner spare areas 20 for the drive 31 and the drive 32. Moreover, it identifies the optical disk 38 and the optical disk 39, which have matching manufacturer numbers and revision numbers, as optical disks of the same lot (i.e., optical disks which were produced with the same stamper), and designates respectively different sizes of inner spare areas 20 for the drive 33 and the drive 34.

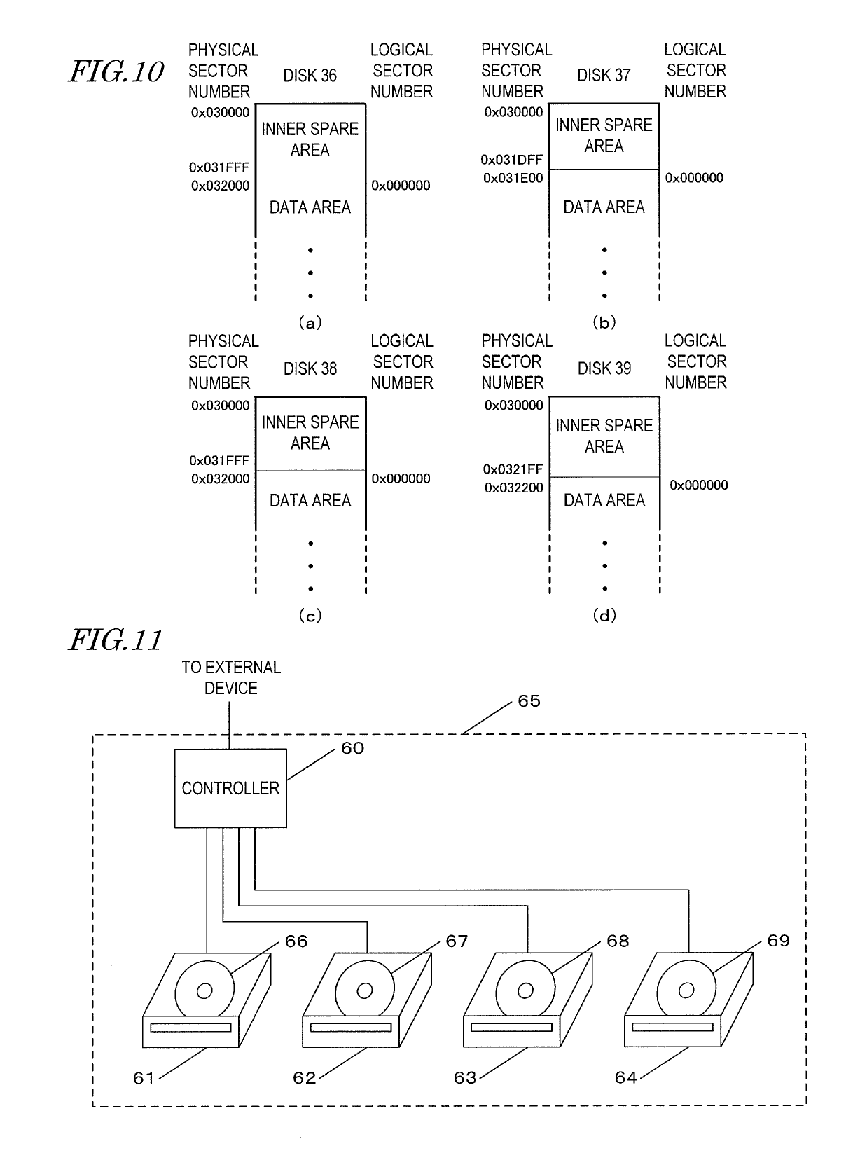

An example of this will be described with reference to FIG. 10. FIG. 10 is a diagram of allocation of inner spare areas 20 according to Embodiment 2 of the present invention. In accordance with an instruction from the controller 30, the drive 31 assigns sectors of physical sector numbers 0x030000 to 0x031FFF of the optical disk 36 as an inner spare area 20, as shown in FIG. 10(a). The drive 32 assigns sectors of physical sector numbers 0x030000 to 0x031DFF of the optical disk 37 as an inner spare area 20, as shown in FIG. 10(b). The drive 33 assigns sectors of physical sector numbers 0x030000 to 0x031FFF of the optical disk 38 as an inner spare area 20, as shown in FIG. 10(c). The drive 34 assigns sectors of physical sector numbers 0x030000 to 0x0321FF of the optical disk 39 as an inner spare area 20, as shown in FIG. 10(d).

Thus, respectively different sizes are allocated to the spare areas of the optical disks 36 and 37, which are of the same lot (the same stamper). Moreover, respectively different sizes are allocated to the spare areas of the optical disks 38 and 39, which are of the same lot (the same stamper).

Moreover, as shown in FIG. 10, the smallest logical sector number, i.e., the logical sector number 0x000000, is assigned to different physical sector numbers in the optical disks 36 and 37 of the same lot (the same stamper). Moreover, the smallest logical sector number, i.e., the logical sector number 0x000000, is assigned to different physical sector numbers in the optical disks 38 and 39 of the same lot (the same stamper).

Specifically, in the optical disk 36, the smallest logical sector number, i.e., the logical sector number 0x000000, is assigned to the physical sector number 0x032000. In the optical disk 37, the smallest logical sector number, i.e., the logical sector number 0x000000, is assigned to the physical sector number 0x031E00.

In the optical disk 38, the smallest logical sector number, i.e., the logical sector number 0x000000, is assigned to the physical sector number 0x032000. In the optical disk 39, the smallest logical sector number, i.e., the logical sector number 0x000000, is assigned to the physical sector number 0x032200.

Herein, the inner spare areas 20 of the optical disk 36 and the optical disk 38 have the same size. However, there is no data reliability problem even if data belonging to the same stripe is placed at the same physical sector number, because it is known from their manufacturer numbers or revision numbers that different stampers were used in the production of the optical disk 36 and the optical disk 38.

Thus, the optical disk array apparatus of the present embodiment includes a plurality of recording/reproduction devices (drives) which record and reproduce data on optical disks. Moreover, the optical disk array apparatus of the present embodiment includes a determination section and an assignment section (controller 30). In this state, for the respective optical disks mounted in the recording/reproduction devices, the determination section determines the stamper for each optical disk. Moreover, in any optical disks sharing the same stamper, the assignment section assigns the smallest logical sector number of each optical disk to different physical sector numbers.

Based on the manufacturer numbers and revision numbers of the optical disks 36 to 39, the controller 30 determines whether the same stamper was shared or not, and ensures that any optical disk sharing the same stamper during production have different sizes of inner spare areas 20. As a result, in any optical disks of the same lot (the same stamper), data belonging to the same stripe is recorded at sectors of different physical sector numbers of the respective optical disks. As a result, the probability of occurrence of read errors due to interferences of adjacent guide grooves and/or insufficient formation of guide grooves can be leveled out, and the maximum probability of read errors can be kept small. Moreover, the size difference between the inner spare areas 20 of the optical disks 36 to 39 can be kept minimum, whereby deterioration in the access rate at the time of replacement recording can be minimized.

Note that information other than manufacturer numbers and revision numbers may be used for identifying optical disks of the same lot (the same stamper). In the case of using reproduced information from optical disks for identifying optical disks of the same lot (the same stamper), information which is recorded by the meandering shape of guide grooves and/or prepit positions may be used. If the information which is recorded by the meandering shape of guide grooves and/or prepit positions differs even partly, such optical disks can be identified as optical disks which were produced with different stampers. For example, parameter information for recording or the like is also available for the identification of optical disks of the same lot (the same stamper). Otherwise, optical disks of the same lot (the same stamper) may be identified based on physical characteristics, such as reflectance of the optical disks.

Note that, in Embodiment 1 or 2 of the present invention, the size of the outer spare area 22 may be selected so that a total of the sizes of the inner spare area 20 and the outer spare area 22 is equal among the optical disks 36 to 39.

In other words, the assignment section of the optical disk array apparatus of Embodiment 1 or 2 may carry out allocation so that a total of the size of the spare area (inner spare area) located at the leading end of the data area and the size of the spare area (outer spare area) located at the trailing end of the data area is equal among the plurality of optical disks.

In this case, since the data areas 21 of the optical disks 36 to 39 have the same size, maximum use of the data zones 11 can be made, without leaving wasted regions therein.

In the present embodiment, as one example, it is illustrated that the smallest logical sector number is assigned to respectively different physical sector numbers in the optical disks 36 and 37 of the same lot (the same stamper) (or the optical disks 38 and 39). Also as one example, it is illustrated that respectively different sizes are allocated for the spare areas (inner spare areas) located at the leading end of each data area in the optical disks 36 and 37 of the same lot (the same stamper) (or the optical disks 38 and 39). However, the construction of the present embodiment is not limited thereto.

For example, assume that the optical disks 36 to 38 excluding the optical disk 39 are optical disks of the same lot (the same stamper), among the optical disks 36 to 39. In this case, the smallest logical sector number may be assigned to respectively different physical sector numbers in all of the optical disks 36 to 38. Moreover, in all of the optical disks 36 to 38, respectively different sizes may be allocated for the spare areas (inner spare areas) located at the leading end of each data area.

Furthermore, in the case where the optical disks 36 to 38 excluding the optical disk 39 are optical disks of the same lot (the same stamper), only the smallest logical sector number of one optical disk among the optical disks 36 to 38 may be assigned to a different physical sector number from the physical sector number to which the smallest logical sector number of any other optical disk in the same lot (the same stamper) is assigned.

Similarly, to only the spare area (inner spare area) located at the leading end of the data area of one optical disk among the optical disks 36 to 38, a different size from the size of the spare area (inner spare area) located at the leading end of the data area of any other optical disk in the same lot (the same stamper) may be allocated.

This is not limited to there being only one such optical disk. Specifically, when optical disks of the same lot (the same stamper) are mounted in n (which is an integer such that 2≦n) drives among the plurality of drives included in the optical disk array apparatus, in those optical disks which are mounted in m (which is an integer such that 1≦m≦n) drives among the n drives, the smallest logical sector number of each may be assigned to a different physical sector number from a physical sector number to which the smallest logical sector number of an optical disk mounted in any other drive among the m drives is assigned.

Similarly, to the spare area (inner spare area) located at the leading end of the data area of each of those optical disks mounted in m drives, a different size from the size of the spare area (inner spare area) located at the leading end of the data area of an optical disk mounted in any other drive may be allocated.

However, in the case where n is such that 3≦n and m is such that 1≦m<n, among the optical disks mounted in the n drives, there may be a combination(s) of optical disks in which the smallest logical sector number is assigned to the same physical sector number as one another. Similarly, among the optical disks mounted in the n drives, there may be a combination(s) of optical disks the sizes of whose spare areas (inner spare areas) located at the leading end of each data area are designated to be the same size as one another.

However, in such cases, too, in the optical disk(s) mounted in at least one drive among the n drives, data in the same stripe can be recorded at a sector of a different physical sector number.

Therefore, increase in the aforementioned probability oscillation of reproduction errors is reduced in the present invention, as compared to any construction in which data in the same stripe is recorded to sectors of the same physical sector number in all of a plurality of optical disks. In other words, data reliability can be enhanced.

It is preferable that, as was mainly so described in the present embodiment, the smallest logical sector number is assigned to mutually different physical sector numbers among all (i.e., m=n) of the optical disks of the same lot (the same stamper). Similarly, preferably among all (i.e., m=n) of the optical disks of the same lot (the same stamper), respectively different sizes are allocated to the spare areas (inner spare areas) located at the leading end of each data area.

As a result, in all of the optical disks of the same lot (the same stamper), data in the same stripe can be recorded to sectors of different physical sector numbers. Therefore, the increase in the aforementioned probability oscillation of reproduction errors can be reduced to the largest degree. In other words, data reliability can be enhanced.

### Embodiment 3

Embodiment 3 of the present invention will be described with reference to FIG. 11. FIG. 11 is a block diagram showing the construction of an optical disk array apparatus 65 according to Embodiment 3 of the present invention. The optical disk array apparatus 65 includes a controller 60 and drives 61 to 64. Optical disks 66 to 69 are mounted in the drives 61 to 64. The aggregate of optical disks 66 to 69 will be referred to as an optical disk array.

The optical disk array apparatus 65 is connected to an external device (not shown) via the controller 60, so that the whole functions as RAID4. For any recording data which is input from the external device, the controller 60 determines, on the basis of a logical address, a drive and a logical sector number to which it is to be recorded, and issues a recording command to the corresponding drive 61 to 63. Furthermore, a recording command for parity data, which is generated from the recording data that is input from the external device, is issued to the drive 64. In accordance with the recording commands from the controller 60, the drives 61 to 64 record the recording data and the parity data to the mounted optical disks 66 to 69.

Moreover, before a first recording is performed for the mounted optical disks 66 to 69, the drives 61 to 64 format the optical disks to assign the logical sector number 0x000000 to physical sector numbers. Prior to formatting, the controller 60 designates respectively different physical sector numbers for the drives 61 to 64 as the physical sector numbers to which the logical sector number 0x000000 is assigned.

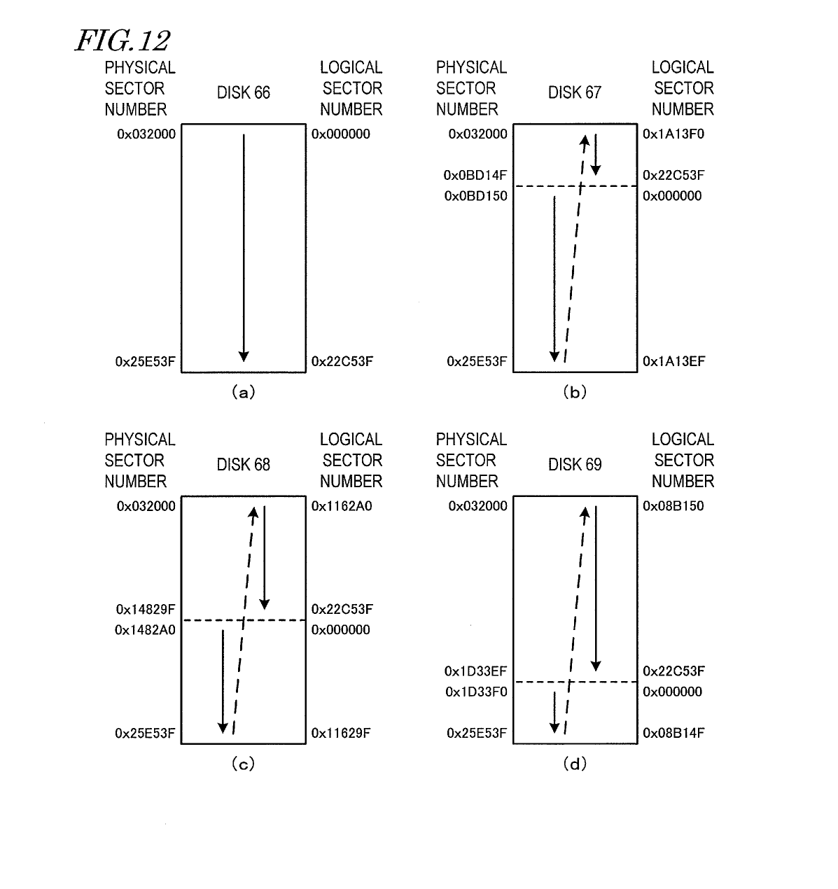

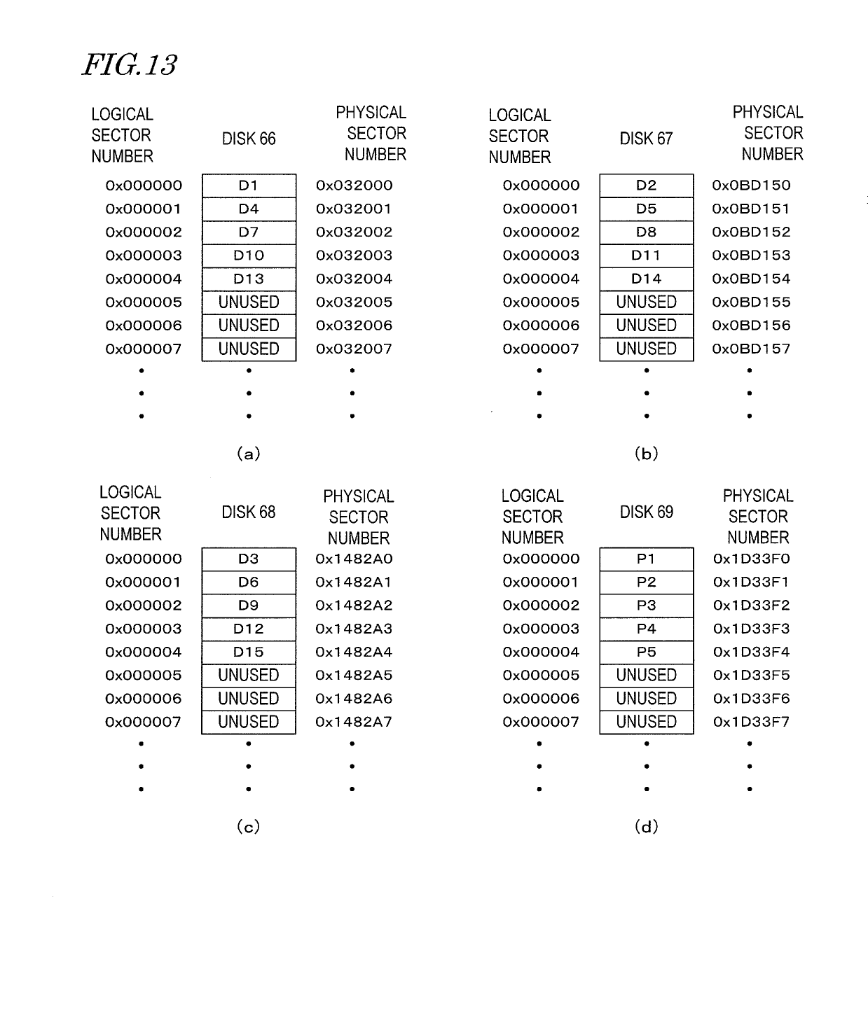

An example thereof will be described with reference to FIG. 12. FIG. 12 is a diagram showing assignment of the logical sector number 0x000000 and physical sector numbers according to Embodiment 3 of the present invention. In accordance with an instruction from the controller 60, the drive 61 assigns the logical sector number 0x000000 to a sector of the physical sector number 0x032000 of the optical disk 66, as shown in FIG. 12(a). As shown in FIG. 12(b), the drive 62 assigns the logical sector number 0x000000 to a sector of the physical sector number 0x0BD150 of the optical disk 67. As shown in FIG. 12(c), the drive 63 assigns the logical sector number 0x000000 to a sector of the physical sector number 0x1482A0 of the optical disk 68. As shown in FIG. 12(d), the drive 64 assigns the logical sector number 0x000000 to a sector of the physical sector number 0x1D33F0 of the optical disk 69.

The stripe construction and the assignment of logical sector numbers may be similar to the assignment for the optical disks 36 to 39 according to Embodiment 1 of the present invention, and the descriptions thereof are omitted here.

The relationship between the logical sector numbers which are assigned to recording data and parity data and the physical sector numbers at which such data are actually recorded will be described with reference to FIG. 13.

FIG. 13 is a diagram showing assignment of logical sector numbers and physical sector numbers according to Embodiment 3 of the present invention. Recording data D1 is recorded at a sector of the physical sector number 0x032000 of the optical disk 66. Recording data D2 is recorded at a sector of the physical sector number 0x0BD150 of the optical disk 67. Recording data D3 is recorded at a sector of the physical sector number 0x1482A0 of the optical disk 68. Recording data D4 is recorded at a sector of the physical sector number 0x032001 of the optical disk 66. Recording data D5 is recorded at a sector of the physical sector number 0x0BD151 of the optical disk 67. Recording data D6 is recorded at a sector of the physical sector number 0x1482A1 of the optical disk 68. Recording data D7 is recorded at a sector of the physical sector number 0x032002 of the optical disk 66. Recording data D8 is recorded at a sector of the physical sector number 0x0BD152 of the optical disk 67. Recording data D9 is recorded at a sector of the physical sector number 0x1482A2 of the optical disk 68. Recording data D10 is recorded at a sector of the physical sector number 0x032003 of the optical disk 66. Recording data D11 is recorded at a sector of the physical sector number 0x0BD153 of the optical disk 67. Recording data D12 is recorded at a sector of the physical sector number 0x1482A3 of the optical disk 68. Recording data D13 is recorded at a sector of the physical sector number 0x032004 of the optical disk 66. Recording data D14 is recorded at a sector of the physical sector number 0x0BD154 of the optical disk 67. Recording data D15 is recorded at a sector of the physical sector number 0x1482A4 of the optical disk 68. Parity data P1 is recorded at a sector of the physical sector number 0x1D33F0 of the optical disk 69. Parity data P2 is recorded at a sector of the physical sector number 0x1D33F1 of the optical disk 69. Parity data P3 is recorded at a sector of the physical sector number 0x1D33F2 of the optical disk 69. Parity data P4 is recorded at a sector of the physical sector number 0x1D33F3 of the optical disk 69. Parity data P5 is recorded at a sector of the physical sector number 0x1D33F4 of the optical disk 69.

Since the recording data which are recorded in this manner constitute RAID4, even if one piece of recording data in the same stripe becomes unable to read, it can be restored from the other recording data and the parity data in that stripe. For example, if D3 becomes unable to read, D3 can be determined and restored through calculation from the other recording data and the parity data (D1, D2, P1) in the stripe that contains D3.

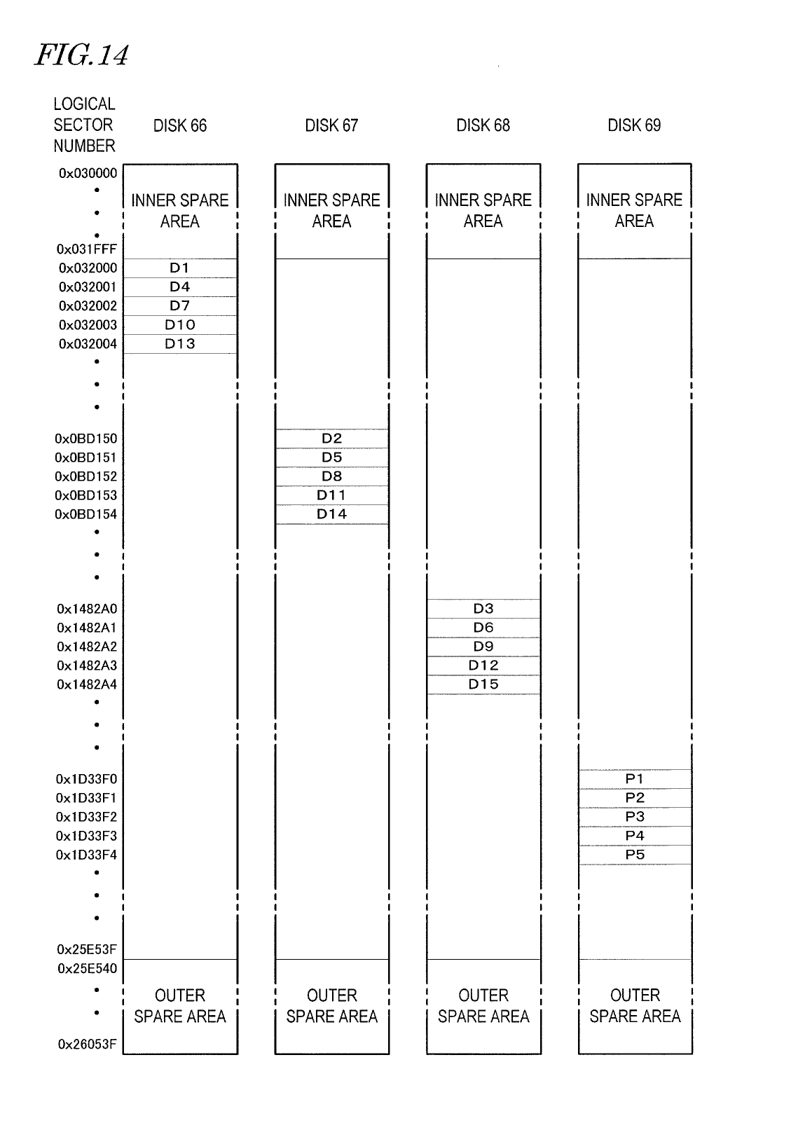

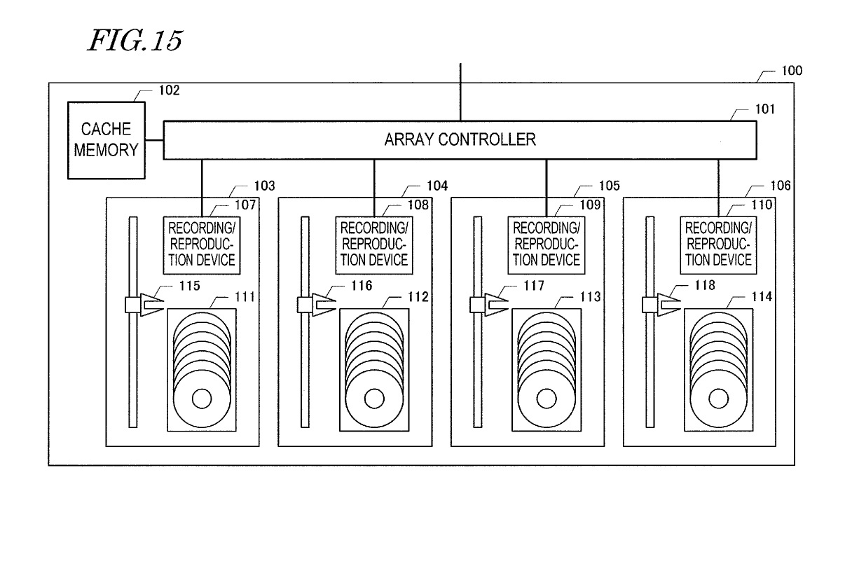

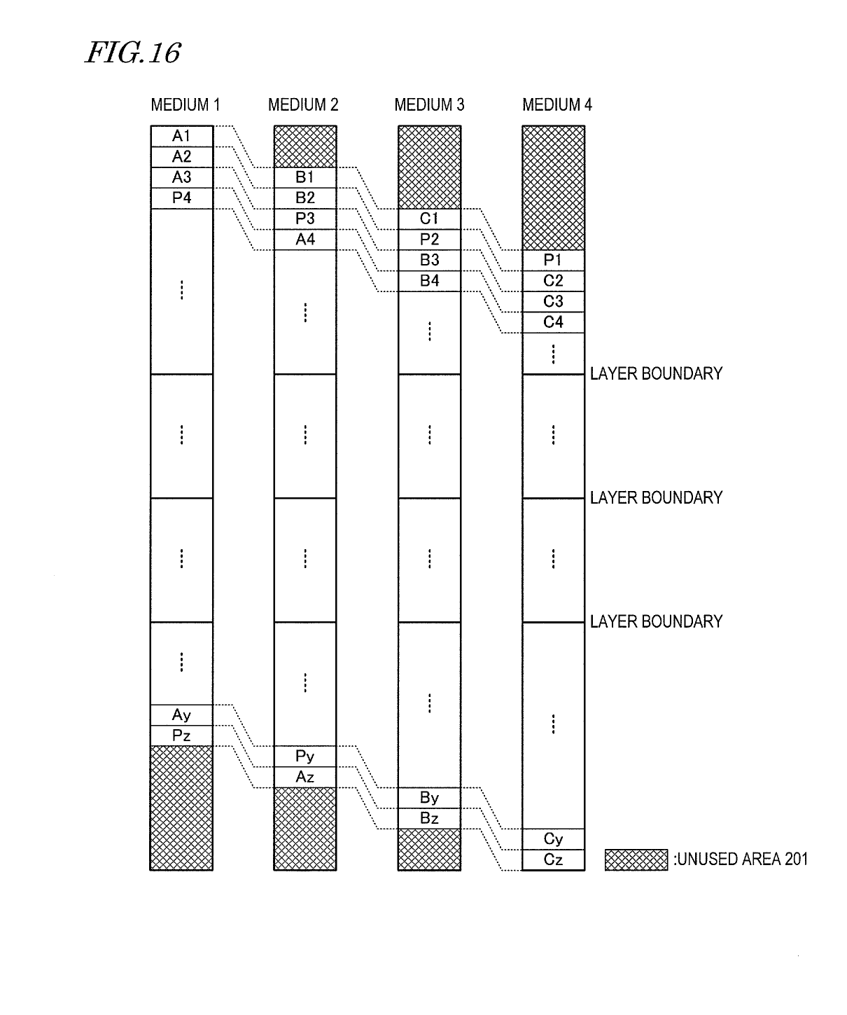

By ensuring that the logical sector number 0x000000 is assigned to respectively different physical sector numbers among the disks composing the optical disk array, as shown in FIG. 14, data belonging to the same stripe is recorded at sectors of different physical sector numbers of the respective optical disks. As a result, the probability of occurrence of read errors due to interferences of adjacent guide grooves and/or insufficient formation of guide grooves can be leveled out, and the maximum probability of read errors can be kept small.

Note that in any optical disk in which the logical sector number 0x000000 is assigned to anywhere other than the physical sector number at the leading end of the data area, the next logical sector number to a logical sector number which is assigned to the final physical sector number of the data area may be assigned to the physical sector number at the leading end of the data area.

For example, in the optical disk 67 shown in FIG. 12, the logical sector number 0x1A13F0, which is next to the logical sector number 0x1A13EF assigned to the final physical sector number 0x25E53F of the data area, is assigned to the physical sector number 0x032000 at the leading end of the data area. In the optical disk 68, the logical sector number 0x1162A0, which is next to the logical sector number 0x11629F assigned to the final physical sector number 0x25E53F of the data area, is assigned to the physical sector number 0x032000 at the leading end of the data area. In the optical disk 69, the logical sector number 0x08B150, which is next to the logical sector number 0x08B14F assigned to the final physical sector number 0x25E53F of the data area, is assigned to the physical sector number 0x032000 at the leading end of the data area.

As described above, in the present embodiment, each optical disk includes a data area. In this state, in any optical disk in which the smallest logical sector number is assigned to a physical sector number which is not at the leading end of the data area, the assignment section of the optical disk array apparatus ensures that the next logical sector number to a logical sector number which is assigned to the physical sector number of the trailing end of the data area is assigned to the physical sector number at the leading end of the data area.

As a result, every one of the logical sector numbers 0x000000 to 0x22C53F of the optical disks 66 to 69 is assigned to some physical sector number, thus utilizing the data area without waste.

Note that the aforementioned construction of the present Embodiment 3 may be combined with the constructions of Embodiments 1 and 2 described above.

Although the sizes of the inner spare area and the outer spare area are described as 0x2000 sectors, any other size may be adopted, and the inner spare area and the outer spare area may be different in size. Moreover, the sizes of the inner spare area and the outer spare area may differ among optical disks 66 to 69. The size may be 0, so that no spare area is provided.

Although it is illustrated that the physical sector numbers to which the logical sector number 0x000000 is assigned are designated by the controller 60 to the drives 61 to 64 in advance, it may be the drives 61 to 64 themselves that determine respectively different predetermined physical sector numbers. In other words, although the present embodiment illustrates the assignment section as being the controller 60, the drives 61 to 64 themselves may each include its own assignment section.

Note that formatting of the optical disks may be executed when a command to initialize the optical disk array comes from an external device.

Note that the optical disks used may be of a type having a plurality of recording layers. For example, in the case where optical disks having four recording layers are used, the leading logical address may be assigned to the leading ends of the data areas of different recording layers.

Note that influences of the stamper on defects can be further reduced by allowing the physical sector numbers to which the logical sector number 0x000000 is assigned to have as much difference as possible between optical disks. For example, every physical sector number to which the logical sector number 0x000000 is assigned may be varied by a size obtained by equally dividing the data area by the number of drives composing the optical disk array apparatus. Moreover, every physical sector number to which the logical sector number 0x000000 is assigned may be varied by a length obtained by equally dividing the length from a radial position at the leading end of a data area to a radial position at the trailing end of the data area.

Note that, in the case where a constant-angular-velocity recording is performed on an optical disk which is constant-linear-velocity formatted, it is better if there is not much disk-to-disk difference between physical sector numbers to which the logical sector number 0x000000 is assigned. Recording under a constant angular velocity results in the recording transfer rate becoming smaller toward the inner periphery. Therefore, if the physical sector numbers to which the logical sector number 0x000000 is assigned are equally differentiated among drives, there will always be a recording drive at the inner periphery side, whose recording speed bottlenecks the overall recording speed. As for interferences of adjacent guide grooves, differentiations on the order of several tracks will level out the probability of occurrence of read errors.

Similarly to Embodiment 2 of the present invention, it may only be among optical disks of the same lot that the logical sector number 0x000000 are assigned to respectively different physical sector numbers. Especially in the case where a constant-angular-velocity recording is performed on an optical disk which is constant-linear-velocity formatted, the overall recording speed can be minimized. Moreover, the recording data buffer can be reduced for the amount of time required for moving from the trailing end of a data area to the beginning of a data area in continuous recording.

Although Embodiments 1 to 3 of the present invention illustrate an exemplary RAID4 constructed with four drives, the number of drives may be increased or decreased, and the present invention is also applicable to other RAID constructions such as RAID1, RAID5, and RAID6.

Note that rewritable type optical disks or write-once type optical disks may be adopted as the optical disks to be used in Embodiments 1 to 3 of the present invention.

In the case where replacement recording is to be performed in Embodiments 1 to 3 of the present invention, the destination of replacement recording may be selected so that data in the same stripe will not receive the same physical sector number.

Instead of sectors, blocks defining units of error correcting codes may be used. In this case, the logical sector numbers and the physical sector numbers should read respectively as logical block numbers and physical block numbers.

In Embodiments 1 to 3 of the present invention, management information may be recorded in a place other than the lead-in zone 10, or recorded on a separate storage device.

Note that the processes by the optical disk array apparatuses of Embodiments 1 to 3 of the present invention may be implemented in software. In this case, a CPU may serve as the controller, whereby a so-called software RAID is constituted. By operating in accordance with a program which is stored in an internal or external storage medium, the CPU is able to execute the aforementioned processes.

### Embodiment 4

FIG. 15 is a block diagram showing an information storage medium library array apparatus 100 according to Embodiment 4 of the present invention.

In FIG. 15, the array controller 101 is a controller which controls information storage medium library devices 103 to 106 so as to realize an array structure. The array controller 101 uses a cache memory 102, in order to temporarily retain data which is read from the information storage medium library devices 103 to 106 and temporarily retain data to be recorded to the information storage medium library devices 103 to 106. Each of the information storage medium library devices 103 to 106 is composed of a recording/reproduction device 107 to 110, a cabinet 111 to 114, and a carriage 115 to 118. The recording/reproduction device 107 to 110 is an apparatus which performs data reproduction/recording on a mounted information storage medium, whereas the cabinet 111 to 114 accommodates a plurality of information storage media. The carriage 115 to 118 carries an information storage medium between the recording/reproduction device 107 to 110 and the cabinet 111 to 114. In this example, the information storage media are optical disks.

In Embodiment 4, RAID5 is constructed with four information storage media which are mounted in the recording/reproduction devices 107 to 110, each having a plurality of recording layers.

FIG. 16 is a diagram showing positioning of data to be recorded in user data regions of the information storage media according to Embodiment 4. Each information storage medium in FIG. 16 is composed of four recording layers.

In FIG. 16, Media 1 to 4 are optical disks mounted in the recording/reproduction devices 107 to 110 respectively, such that respectively different sizes of unused areas 201 are provided at the leading ends of Media 2 to 4. Assuming that the unused area 201 at the leading end of Medium 2 has a size s, the unused area 201 at the leading end of Medium 3 is 2s, and the unused area 201 at the leading end of Medium 4 is 3s. Also, respectively different sizes of unused areas 201 are provided at the trailing ends of Media 1 to 3. It is assumed that the unused area 201 at the trailing end of Medium 1 is 3s, the unused area 201 at the trailing end of Medium 2 is 2s, and the unused area 201 at the trailing end of Medium 3 is s. As the size s, an integer (which is 1 or more) multiple of the stripe size is selected while considering the amount of time required for switching between recording layers for reproduction. Now, the stripe size is the size of a region composing a stripe corresponding to a single information storage medium. In FIG. 16, the size is chosen to be twice the stripe size for convenience of explanation.

In FIG. 16, A1 of Medium 1, B1 of Medium 2, C1 of Medium 3, and P1 of Medium 4 together compose a stripe. Similarly, A2 of Medium 1, B2 of Medium 2, P2 of Medium 3, and C2 of Medium 4 together compose a stripe. Subsequent regions similarly compose stripes, such that the last stripe is composed by Pz of Medium 1, Az of Medium 2, Bz of Medium 3, and Cz of Medium 4. Note that any block beginning with P is a parity block.

When there is any point on an information storage medium from which data cannot be reproduced, data on other information storage media composing the stripe are used for restoration. For example, if B2 of Medium 2 cannot be reproduced in FIG. 16, then the data in A2 of Medium 1, P2 of Medium 3, and C2 of Medium 4 are used to calculate an exclusive OR of the data at the same byte position in A2, P2, and C2, thus restoring the data in B2 of Medium 2.

Thus, the information storage medium library array apparatus 100 has redundancy for enabling data restoration when the data of at least one information storage medium composing a stripe cannot be reproduced. By using such stripe redundancy, recovery from reproduction errors is possible.

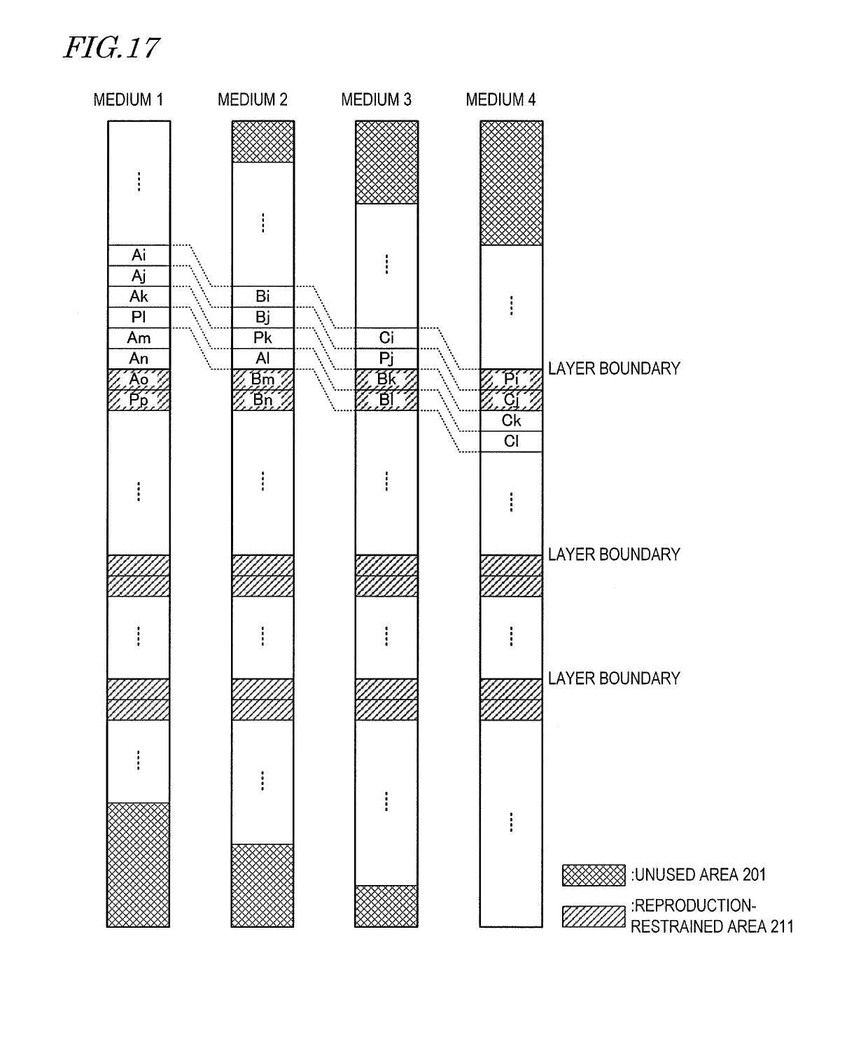

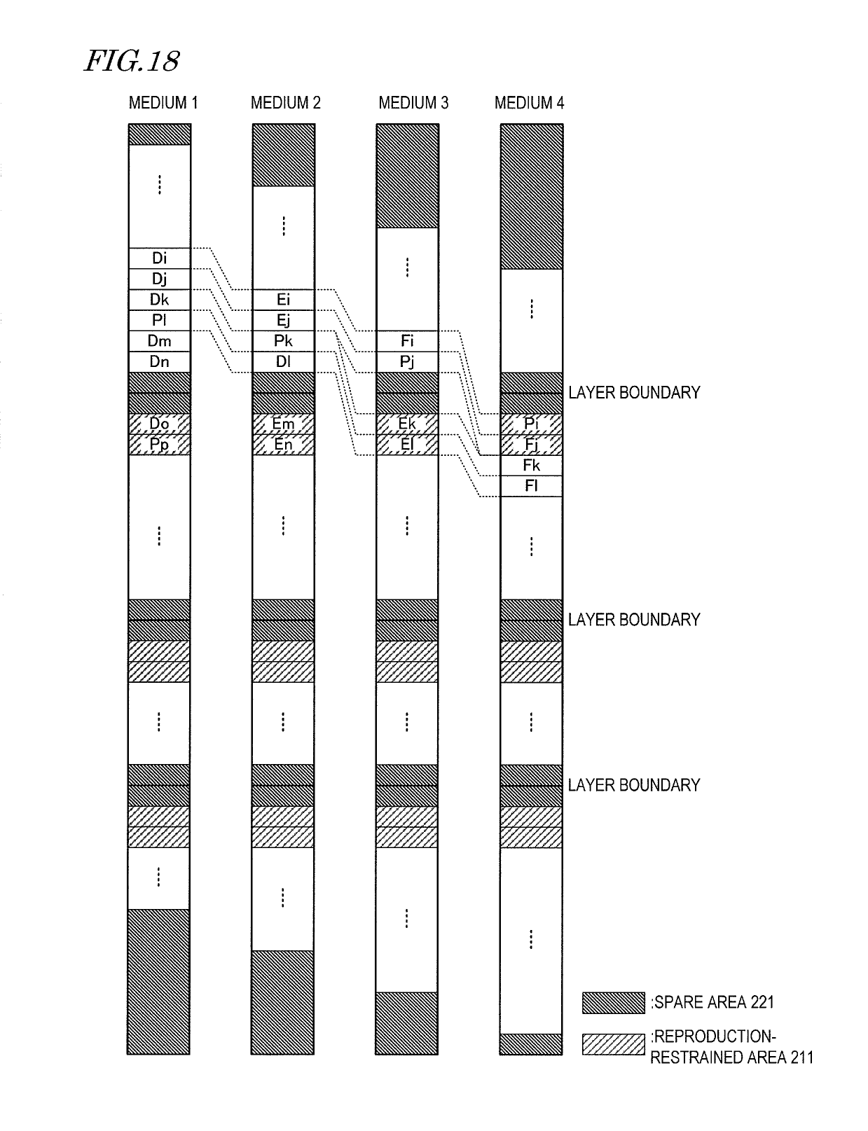

FIG. 17 shows a state of stripes near switching between recording layers of the information storage media of FIG. 16.

In FIG. 17, Ai of Medium 1, Bi of Medium 2, Ci of Medium 3, and Pi of Medium 4 together compose a stripe. Similarly, Aj of Medium 1, Bj of Medium 2, Pj of Medium 3, and Cj of Medium 4 together compose a stripe. Ak of Medium 1, Pk of Medium 2, Bk of Medium 3, and Ck of Medium 4 together compose a stripe. Pl of Medium 1, Al of Medium 2, Bl of Medium 3, and Cl of Medium 4 together compose a stripe.

An operation when the information storage medium library array apparatus 100 reproduces data near a switching between recording layers of the information storage medium shown in FIG. 17 will be described.

The array controller 101 restrains the information storage medium library device 106 from reproducing data in Pi and Cj, which are located immediately after switching of recording layers in Medium 4 of FIG. 17. A position located immediately after switching of recording layers is a position in the data area that will be the first to be accessed after the switching. In other words, the array controller 101 controls the information storage medium library device 106 so that the information storage medium library device 106 will not reproduce data from Pi and Cj. In the meanwhile, the array controller 101 restores data in Pi of Medium 4 from the data which are reproduced from Ai of Medium 1, Bi of Medium 2, and Ci of Medium 3 by the remaining information storage medium library devices 103 to 105, and similarly, the array controller 101 restores Cj of Medium 4 from the data which are reproduced from Aj of Medium 1, Bj of Medium 2, and Pj of Medium 3 by the information storage medium library devices 103 to 105. Herein, during the data restoration while restraining data reproduction from Pi and Cj of Medium 4, the information storage medium library device 106 performs switching to the recording layer to be reproduced and also prepares itself to reproduce Ck, which is the subsequent region of Cj. Similarly, the array controller 101 restrains the information storage medium library devices 105, 104, and 103 from reproducing data in, respectively: Bk and Bl, which are located immediately after switching of recording layers in Medium 3 of FIG. 17; Bm and Bn, which are located immediately after switching of recording layers in Medium 2; and Ao and Pp, which are located immediately after switching of recording layers in Medium 1. From the data which are reproduced from the other information storage media composing the same stripe by the remaining three of the information storage medium library devices 103 to 106, the array controller 101 restores the data whose reproduction has been restrained.

In this manner, similarly for any other switching between recording layers, the information storage medium library array apparatus 100 restrains data reproduction immediately after switching of recording layers in the information storage medium, restores the data whose reproduction has been restrained from the data which are reproduced from other information storage media, and, during the data restoration while restraining data reproduction, performs switching of recording layers and prepares itself to reproduce a subsequent portion to the region whose reproduction has been restrained, whereby continuous data reproduction is enabled even upon switching between recording layers, without suspending data reproduction.

Thus, the information storage medium library array apparatus of the present embodiment includes a plurality of recording/reproduction devices. In this state, an information storage medium having a plurality of recording layers is mounted in each recording/reproduction device. A disk array is constituted by the information storage media mounted in the respective recording/reproduction devices. A plurality of stripes are formed in the disk array. It has redundancy for enabling data restoration when the data of at least one information storage medium composing a stripe cannot be reproduced. In this state, data composing one stripe is placed at physically different positions of the information storage media. As a result of this, the information storage medium library array apparatus ensures that the timing of switching recording layers of the information storage medium is different among the recording/reproduction devices. Then, each recording/reproduction device restrains data reproduction in a predetermined region range immediately after switching of recording layers in the information storage medium. The information storage medium library array apparatus restores the data in the predetermined region range from the data reproduced by the remaining recording/reproduction devices, excluding the recording/reproduction device which has been restrained from reproducing data.

With this construction, continuous data reproduction is enabled even upon switching between recording layers, without suspending data reproduction.

Moreover, while restoring the data in the predetermined region range, the information storage medium library array apparatus of the present embodiment may perform switching to the recording layer to be reproduced in the information storage medium and prepare itself to reproduce data in a subsequent region of the region in which data reproduction has been restrained, in the recording/reproduction device in which data reproduction has been restrained.

In the case where the region in which data reproduction has been restrained is a parity block, the data does not need to be restored from data which are reproduced from other information storage media. For example, Pi of Medium 4 and Pp of Medium 1 in FIG. 17 do not need to be restored.

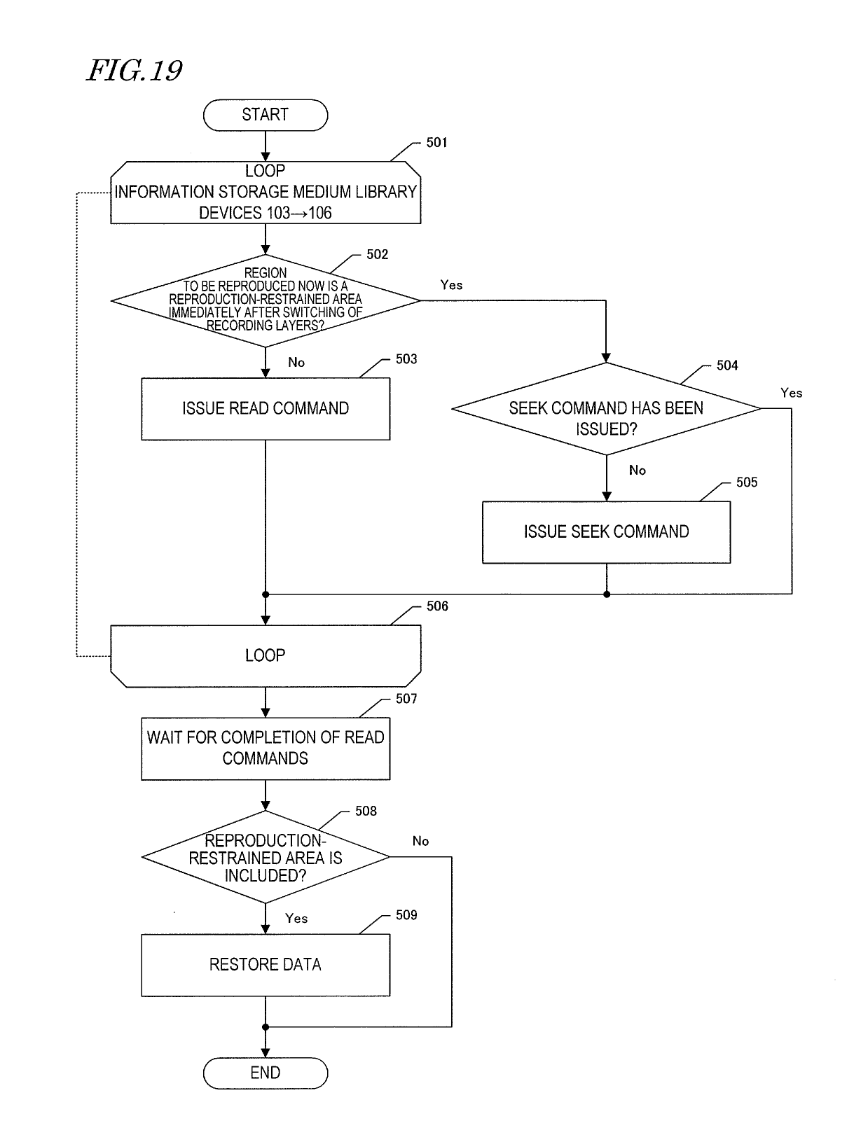

FIG. 19 is a flowchart showing a reproduction operation of the information storage medium library array apparatus 100 of Embodiment 4.

The array controller 101 repeats the steps between step 501 and step 506 for each of the information storage medium library devices 103 to 106.

At step 502, the array controller 101 determines whether the region which is going to be reproduced now is a reproduction-restrained area 211 immediately after switching of recording layers. If it is not a reproduction-restrained area 211, control proceeds to step 503; if it is a reproduction-restrained area 211, control proceeds to step 504. The region determination can be made by, for example, relying on the logical sector number of a reproduction command which is requested at the array controller 101 to determine a physical sector number corresponding to that logical sector number. Alternatively, in the case of read-ahead caching a subsequent region of a reproduction command requested at the array controller 101, the region determination can be made by relying on a logical sector number which is subsequent to the logical sector number of the reproduction command to determine a physical sector number corresponding to the logical sector number.

At step 503, the array controller 101 issues a READ command to the targeted information storage medium library device (one of 103 to 106), and proceeds to a detection of termination of repetition of steps 501 to 506.

At step 504, the array controller 101 determines whether a SEEK command to a subsequent portion to the reproduction-restrained area 211 has already been issued for the targeted information storage medium library device (one of 103 to 106). If it has not been issued, control proceeds to step 505; if it has been issued, control proceeds to a detection of termination of repetition of steps 501 to 506.

At step 505, the array controller 101 issues a command to the targeted information storage medium library device (one of 103 to 106) to SEEK a subsequent portion to the reproduction-restrained area 211. With this SEEK command, a recording/reproduction device (one of 107 to 110) included in the information storage medium library device (one of 103 to 106) performs switching to the recording layer to be reproduced and moves a recording/reproduction head to near a subsequent portion to the region in which reproduction has been restrained. As a result of this, data reproduction is not performed in the reproduction-restrained area 211. Once the SEEK command has been issue, control proceeds to a detection of termination of repetition of steps 501 to 506.

When the processes for each of the information storage medium library devices 103 to 106 are completed, control proceeds to step 507.

At step 507, the array controller 101 waits for the completion of the READ commands having been issued at step 503. When all READ commands issued at step 503 are completed, control proceeds to step 508.

At step 508, the array controller 101 determines whether any region has had its reproduction restrained with respect to any of the information storage medium library devices 103 to 106. If any reproduction-restrained area 211 is included, control proceeds to step 509; if no reproduction-restrained area 211 is included, the process is ended. As has been stated earlier, even when a reproduction-restrained area 211 exists, there is no need to proceed to step 509 if it is a parity block.

At step 509, by using the reproduced data from the other information storage medium library devices (the other three of 103 to 106), the array controller 101 restores the data in the region in which reproduction has been restrained, and the process is ended.

Through the above steps, the information storage medium library array apparatus 100 is able to restrain reproduction in a region immediately after switching of recording layers, and restore the data in the region in which reproduction has been restrained by using reproduced data from the other information storage medium library devices.

Thus, in the information storage medium library array apparatus according to the reproduction control method of the present embodiment, a disk array is constituted by a plurality of information storage media having a plurality of recording layers. A plurality of stripes are formed in the disk array. It has redundancy for enabling data restoration when the data of at least one information storage medium composing a stripe cannot be reproduced. Moreover, data composing one stripe is recorded at physically different positions of information storage media. In this state, the reproduction control method of the present embodiment involves a step of restraining data reproduction in a predetermined region range immediately after switching of recording layers in an information storage medium, and a step of restoring the data in the predetermined region range from the data which are reproduced from the remaining information storage media excluding the information storage medium whose data reproduction has been restrained.

With this construction, continuous data reproduction is enabled even upon switching between recording layers, without suspending data reproduction.

Embodiment 4 illustrates a case where unused areas 201 are provided at the leading ends and trailing ends of information storage media so that the data positioning on each information storage medium is differentiated by a multiple size of the stripe size, while considering the amount of time required for switching between recording layers for reproduction. However, it is preferable to adopt a multiple size of a stripe size which is required for the data reproduction corresponding to a total amount of time for switching to the recording layer to be reproduced and preparing to reproduce a subsequent portion to a region in which data reproduction has been restrained. The amount of time required for the data reproduction of this size may be determined from a disk data transfer rate, which in turn is determined from disk revolutions, or determined from a stream data transfer rate in the case of treating a stream of motion video, audio, or the like.

In Embodiment 4, stripe-construction based recording may also be performed in the unused areas 201 provided at the leading ends and trailing ends of the information storage media, thereby making all regions available for usage.

Furthermore, with information storage media each having spare areas 221 at the leading end and the trailing end of the information storage medium, such that the ratio of the spare areas 221 is changeable, a similar implementation is possible by, as shown in FIG. 18, varying the ratio of the spare areas 221 located at the leading end and the trailing end in each information storage medium, without providing unused areas 201 in the user data region.

Thus, in the information storage medium library array apparatus of the present embodiment, the information storage media may include spare areas 221 at the leading end and the trailing end. In this state, the information storage medium library array apparatus of the present embodiment may place data composing one stripe at physically different positions of the information storage media by using a different ratio between the spare areas 221 at the leading end and the trailing end in each of the information storage media composing the disk array.

### Embodiment 5

In Embodiment 5, an information storage medium set combining a plurality of information storage media is accommodated in each of cabinets 111 to 114, so that one information storage medium in the information storage medium set is carried to a recording/reproduction device 107 to 110 by a carriage 115 to 118. RAID5 is constructed with four information storage medium sets which are mountable to the recording/reproduction devices 107 to 110.

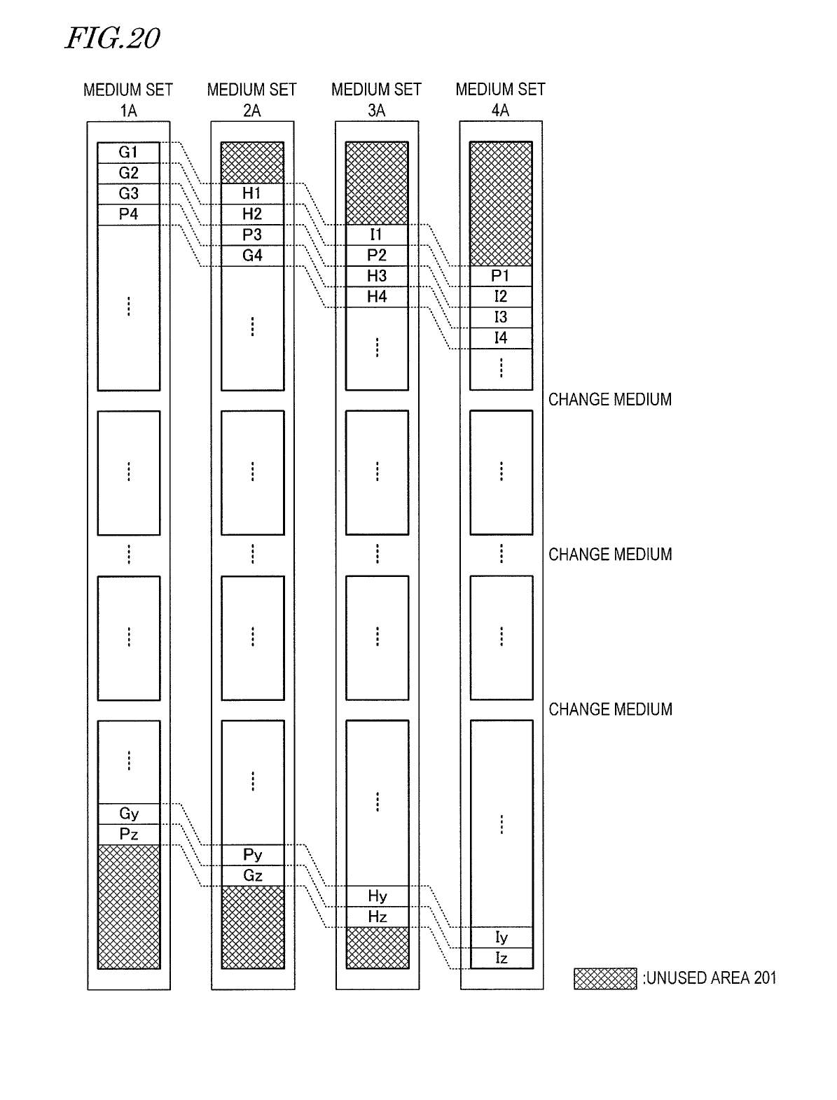

FIG. 20 is a diagram showing data positioning of user data regions to be recorded in the information storage medium sets of Embodiment 5.

In FIG. 20, a medium set 1A is a set of plural information storage media mountable to the recording/reproduction device 107. A medium set 2A is a set of plural information storage media mountable to the recording/reproduction device 108. A medium set 3A is a set of plural information storage media mountable to the recording/reproduction device 109. A medium set 4A is a set of plural information storage media mountable to the recording/reproduction device 110.

At the leading end of the first information storage medium in each of the medium sets 2A to 4A, an unused area 201 of a respectively different size is provided. Assuming that the unused area 201 at the leading end of the first information storage medium in the medium set 2A has a size t, the unused area 201 at the leading end of the first information storage medium in the medium set 3A has a size 2t, and the unused area 201 at the leading end of the first information storage medium in the medium set 4A has a size 3t. Also at the trailing end of the last information storage medium in each of the medium sets 1A to 3A, an unused area 201 of a respectively different size is provided. It is assumed that the unused area 201 at the trailing end of the last information storage medium in the medium set 1A has a size 3t, the unused area 201 at the trailing end of the last information storage medium in the medium set 2A has a size 2t, and the unused area 201 at the trailing end of the last information storage medium in the medium set 3A has a size t. As the size t, an integer (which is 1 or more) multiple of the stripe size is selected while considering the amount of time required for changing the information storage medium to be reproduced. In FIG. 20, the size t is chosen to be twice the stripe size for convenience of explanation.

In FIG. 20, G1 of the medium set LA, H1 of the medium set 2A, I1 of the medium set 3A, and P1 of the medium set 4A together compose a stripe. Similarly, G2 of the medium set 1A, H2 of the medium set 2A, P2 of the medium set 3A, and 12 of the medium set 4A together compose a stripe. Subsequent regions similarly compose stripes, such that the last stripe is composed by the last used region of the last information storage medium in each information storage medium set, i.e., Pz of the medium set 1A, Gz of the medium set 2A, Hz of the medium set 3A, and Iz of the medium set 4A. Note that any block beginning with P is a parity block.

When there is any point on an information storage medium in an information storage medium set from which data cannot be reproduced, data on the information storage media in other information storage medium sets composing the stripe are used for restoration. For example, if H2 of the medium set 2A cannot be reproduced in FIG. 20, then the data in G2 of the medium set 1A, P2 of the medium set 3A, and 12 of the medium set 4A are used to calculate an exclusive OR of the data at the same byte position in G2, P2, and 12, thus restoring the data in H2 of the medium set 2A.

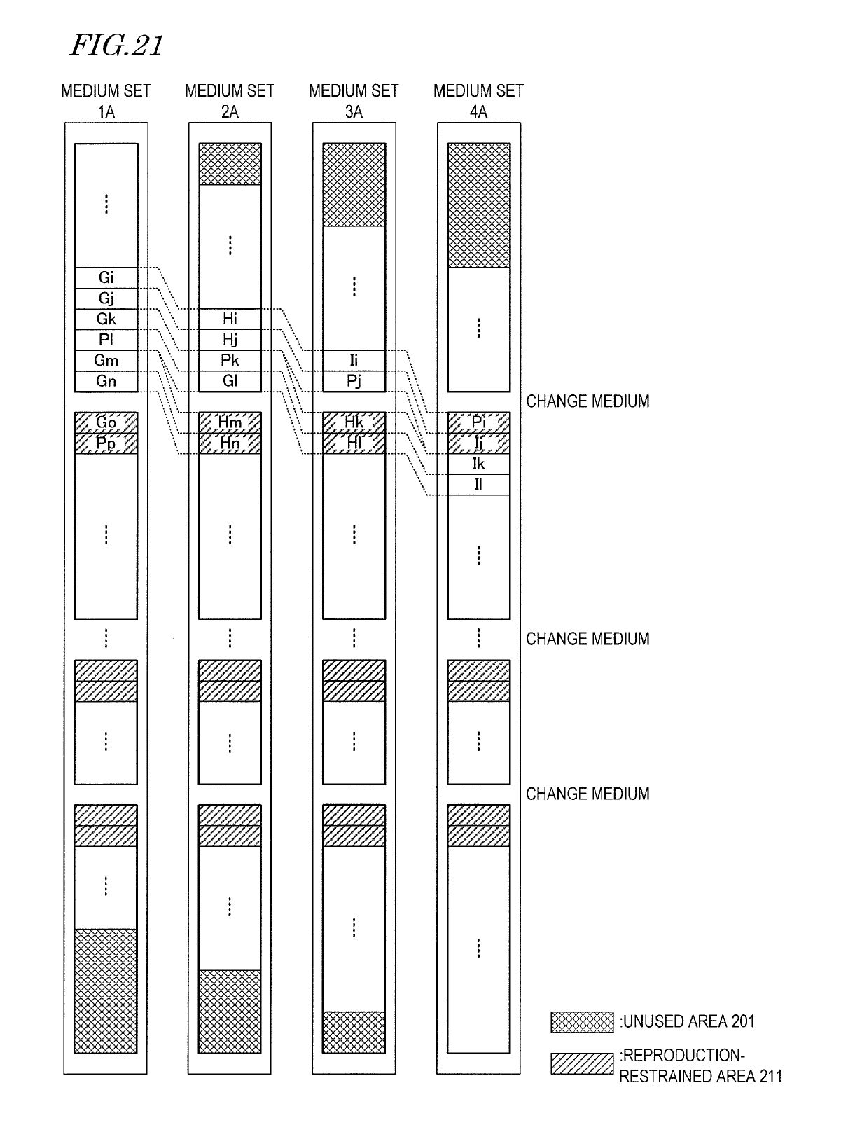

FIG. 21 shows a state of stripes near changes of the information storage media in the information storage medium sets of FIG. 20.

In FIG. 21, Gi of the medium set 1A, Hi of the medium set 2A, Ii of the medium set 3A, and Pi of the medium set 4A together compose a stripe. Similarly, Gj of the medium set 1A, Hj of the medium set 2A, Pj of the medium set 3A, and Ij of the medium set 4A together compose a stripe; Gk of the medium set 1A, Pk of the medium set 2A, Hk of the medium set 3A, and Ik of the medium set 4A together compose a stripe; and Pl of the medium set 1A, Gl of the medium set 2A, Hl of the medium set 3A, and Il of the medium set 4A together compose a stripe.

An operation when the information storage medium library array apparatus 100 reproduces data near a change of the information storage medium in an information storage medium set shown in FIG. 21 will be described.

The array controller 101 restrains the information storage medium library device 106 from reproducing data in Pi and Ij, which are located immediately after a change of the information storage medium in the medium set 4A shown in FIG. 21. A position located immediately after a change of the information storage medium is a position in the data area that will be the first to be accessed after the change. In the meanwhile, the array controller 101 restores data in Pi of the medium set 4A from the data which are reproduced from Gi of the medium set 1A, Hi of the medium set 2A, and Ii of the medium set 3A by the remaining information storage medium library devices 103 to 105, and the array controller 101 restores Ij of the medium set 4A from the data which are reproduced from Gj of the medium set 1A, Hj of the medium set 2A, and Pj of the medium set 3A by the information storage medium library devices 103 to 105. Herein, during the data restoration while restraining data reproduction in Pi and Ij of the medium set 4A, the information storage medium library device 106 changes the information storage medium to reproduce from in the medium set 4A, and prepares itself to reproduce Ik. Similarly, the array controller 101 restrains the information storage medium library devices 105, 104, and 103 from reproducing data in, respectively: Hk and Hl, which are located immediately after a change of the information storage medium in the medium set 3A in FIG. 21; Hm and Hn, which are located immediately after a change of the information storage medium in the medium set 2A; and Go and Pp, which are located immediately after a change of the information storage medium in the medium set 1A. From the data which are reproduced by the remaining three of the information storage medium library devices 103 to 106 from the information storage media in the other information storage medium sets composing the same stripe, the array controller 101 restores the data whose reproduction has been restrained.

In this manner, similarly for any other change of an information storage medium, the information storage medium library array apparatus 100 restrains data reproduction immediately after a change of the information storage medium, and restores the data whose reproduction has been restrained from the data which are reproduced from the information storage media in the other information storage medium sets, and, during the data restoration while restraining data reproduction, performs changing of information storage media and prepares itself to reproduce a subsequent portion to the region whose reproduction has been restrained, whereby continuous data reproduction is enabled even when changing information storage media, without suspending data reproduction.

Thus, the information storage medium library array apparatus of the present embodiment includes a plurality of information storage medium library devices each having a recording/reproduction device, a cabinet, and a carriage. In this state, in the cabinet of each information storage medium library device, an information storage medium set combining a plurality of information storage media is accommodated. Then, in each information storage medium library device, an information storage medium in the information storage medium set is carried between the cabinet and the recording/reproduction device by the carriage, and the recording/reproduction device performs data reproduction. A disk array is constituted by the information storage medium sets accommodated in the cabinets of the respective information storage medium library devices. A plurality of stripes are formed in the disk array. It has redundancy for enabling data restoration when the data of an information storage medium in at least one information storage medium set composing a stripe cannot be reproduced. In this state, data composing one stripe is placed at physically different positions of the information storage media in the information storage medium sets. As a result of this, the information storage medium library array apparatus ensures that the timing of changing the information storage medium in the information storage medium set is different among the information storage medium library devices. Then, each information storage medium library device restrains data reproduction in a predetermined region range immediately after a change of the information storage medium in the information storage medium set. Then, the information storage medium library array apparatus restores the data in the predetermined region range from the data reproduced by the remaining information storage medium library devices, excluding the information storage medium library device which has been restrained from reproducing data.

With this construction, continuous data reproduction is enabled even when changing information storage media, without suspending data reproduction.

Moreover, while restoring the data in the predetermined region range, the information storage medium library array apparatus of the present embodiment may change the information storage medium to be reproduced in the information storage medium set in the information storage medium library device that has been restrained from reproducing data.

In the case where the region in which data reproduction has been restrained is a parity block, data whose reproduction has been restrained does not need to be restored from data which are reproduced from the information storage media in other information storage medium sets. For example, Pi of the medium set 4A and the Pp of the medium set 1A in FIG. 21 do not need to be restored.

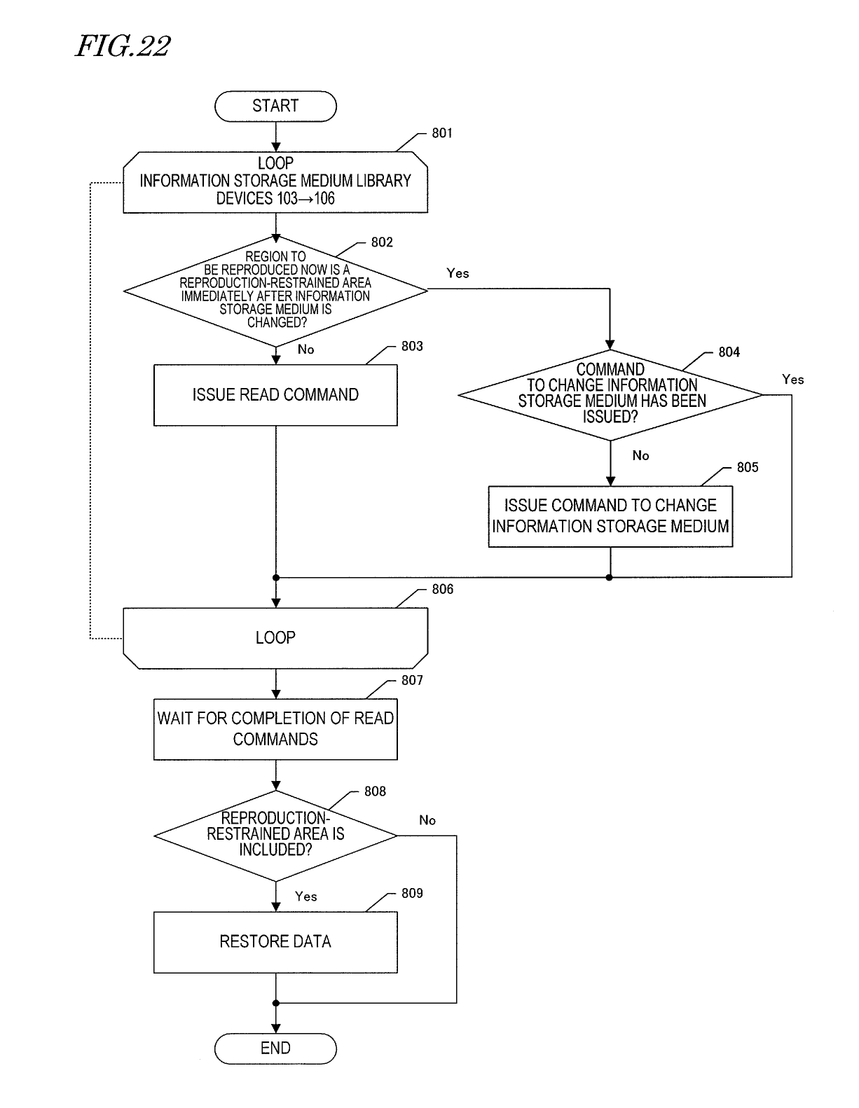

FIG. 22 is a flowchart showing a reproduction operation of the information storage medium library array apparatus 100 according to Embodiment 5.

The array controller 101 repeats the steps between step 801 and step 806 for each of the information storage medium library devices 103 to 106.

At step 802, the array controller 101 determines whether the region which is going to be reproduced now is a reproduction-restrained area 211 immediately after a change of the information storage medium. If it is not a reproduction-restrained area 211, control proceeds to step 803; if it is a reproduction-restrained area 211, control proceeds to step 804. The region determination can be made by, for example, relying on the logical sector number of a reproduction command which is requested at the array controller 101 to determine an information storage medium and a physical sector number corresponding to that logical sector number. Alternatively, in the case of read-ahead caching a subsequent region of a reproduction command requested at the array controller 101, the region determination can be made by relying on a logical sector number which is subsequent to the logical sector number of the reproduction command to determine an information storage medium and a physical sector number corresponding to that logical sector number.

At step 803, the array controller 101 issues a READ command to the targeted information storage medium library device (one of 103 to 106), and proceeds to a detection of termination of repetition of steps 801 to 806.

At step 804, the array controller 101 determines whether a command to change the information storage medium has already been issued for the targeted information storage medium library device (one of 103 to 106). If it has not been issued, control proceeds to step 805; if it has been issued, control proceeds to a detection of termination of repetition of steps 801 to 806.

At step 805, the array controller 101 issues a command to the targeted information storage medium library device (one of 103 to 106) to change the information storage medium, and proceeds to a detection of termination of repetition of steps 801 to 806. Note that, after the change of the information storage medium, data reproduction in the reproduction-restrained area 211 is not performed.

When the processes for each of the information storage medium library devices 103 to 106 are completed, control proceeds to step 807.

At step 807, the array controller 101 waits for the completion of the READ commands having been issued at step 803. When all READ commands issued at step 803 are completed, control proceeds to step 808.

At step 808, the array controller 101 determines whether any region has had its reproduction restrained with respect to any of the information storage medium library devices 103 to 106. If any reproduction-restrained area 211 is included, control proceeds to step 809; if no reproduction-restrained area 211 is included, the process is ended. As has been stated earlier, even when a reproduction-restrained area 211 exists, there is no need to proceed to step 809 if it is a parity block.

At step 809, by using the reproduced data from the other information storage medium library devices (the other three of 103 to 106), the array controller 101 restores the data in the region in which reproduction has been restrained, and the process is ended.

Through the above steps, the information storage medium library array apparatus 100 is able to restrain reproduction in a region immediately after a change of the information storage medium, and restore the data in the region in which reproduction has been restrained by using reproduced data from the other information storage medium library devices.

Thus, in the information storage medium library array apparatus according to the reproduction control method of the present embodiment, a disk array is constituted by a plurality of information storage medium sets each combining a plurality of information storage media. A plurality of stripes are formed in the disk array. It has redundancy for enabling data restoration when the data of an information storage medium in at least one information storage medium set composing a stripe cannot be reproduced. Moreover, data composing one stripe is recorded at physically different positions of information storage media in the information storage medium sets. In this state, the reproduction control method of the present embodiment involves a step of restraining data reproduction in a predetermined region range immediately after a change of the information storage medium in an information storage medium set, and a step of restoring the data in the predetermined region range from the data which are reproduced from the remaining information storage medium sets, excluding the information storage medium set whose data reproduction has been restrained.

With this construction, continuous data reproduction is enabled even when changing information storage media, without suspending data reproduction.

Although Embodiment 5 illustrates that unused areas 201 are provided at the leading ends of the first information storage media in the medium sets 2A to 4A, they may be provided at the trailing ends of the first information storage media in the medium sets 2A to 4A. The requirement is that there be a difference of size t between each sum total of unused areas 201 of the first information storage media in the medium sets 1A to 4A. For example, unused areas 201 may be dispersedly provided in the first information storage media in the medium sets 1A to 4A, with respective sum totals of 2t, 3t, 4t, and 5t. Similarly, although it is illustrated that unused areas 201 are provided at the trailing ends of the last information storage media in the medium sets 1A to 3A, unused areas 201 may be provided at the leading ends of the last information storage media in the medium sets 1A to 3A. The requirement is that there be a difference of size t between each sum total of unused areas 201 of the last information storage media in the medium sets 1A to 4A. For example, unused areas 201 may be dispersedly provided in the last information storage media of the medium sets 1A to 4A, with respective sum totals of 5t, 4t, 3t, and 2t.

Furthermore, in the case of information storage media having spare areas 221, rather than providing unused areas 201 in the user data regions, the size of the spare area 221 existing in each first information storage medium in the medium sets 1A to 4A may be made different by a size t, thus introducing a difference of size t between the size of each user data region. Similarly, the size of the spare area 221 existing in each last information storage medium in the medium sets 1A to 4A may be made different by a size t, thus introducing a difference of size t between the size of each user data region. For example, the spare areas 221 of the first information storage media in the medium sets 1A to 4A may have sizes α, α+t, α+2t, and α+3t, respectively, and the spare areas 221 of the last information storage media in the medium sets 1A to 4A may have sizes α+3t, α+2t, α+t, and α, respectively. Herein, a may be any arbitrary size.

### Embodiment 6

In Embodiment 6, an information storage medium set combining a plurality of information storage media each having a plurality of recording layers is accommodated in each of cabinets 111 to 114, so that one information storage medium in the information storage medium set is carried to a recording/reproduction device 107 to 110 by a carriage 115 to 118. RAID5 is constructed with four information storage medium sets which are mountable to the recording/reproduction devices 107 to 110.

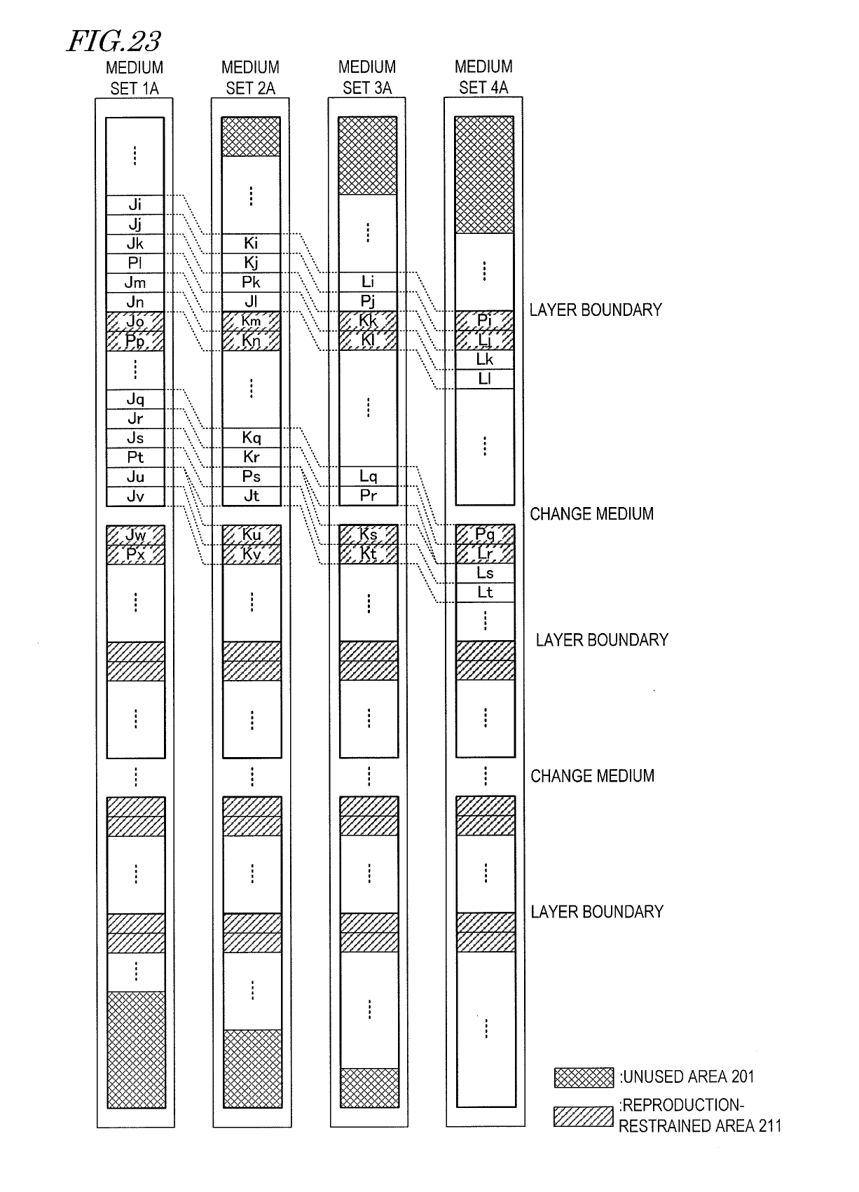

FIG. 23 shows a state of stripes near switching between recording layers and changes of information storage media in the information storage medium sets of Embodiment 6.

In FIG. 23, a medium set 1A is a set of plural information storage media mountable to the recording/reproduction device 107. A medium set 2A is a set of plural information storage media mountable to the recording/reproduction device 108. A medium set 3A is a set of plural information storage media mountable to the recording/reproduction device 109. A medium set 4A is a set of plural information storage media mountable to the recording/reproduction device 110. Similarly to Embodiment 5, an unused area 201 of a respectively different size is provided at the leading end of the first information storage medium in each of the medium sets 2A to 4A, and also an unused area 201 of a respectively different size is provided at the trailing end of the last information storage medium in each of the medium sets 1A to 3A, in Embodiment 6.

In FIG. 23, Ji of the medium set 1A, Ki of the medium set 2A, Li of the medium set 3A, and Pi of the medium set 4A together compose a stripe. Similarly, Jj of the medium set 1A, Kj of the medium set 2A, Pj of the medium set 3A, and Lj of the medium set 4A together compose a stripe. Jk of the medium set 1A, Pk of the medium set 2A, Kk of the medium set 3A, and Lk of the medium set 4A together compose a stripe. Pl of the medium set 1A, Jl of the medium set 2A, K1 of the medium set 3A, and Ll of the medium set 4A together compose a stripe. Moreover, Jq of the medium set 1A, Kg of the medium set 2A, Lq of the medium set 3A, and Pq of the medium set 4A together compose a stripe. Similarly, Jr of the medium set 1A, Kr of the medium set 2A, Pr of the medium set 3A, and Lr of the medium set 4A together compose a stripe. Js of the medium set 1A, Ps of the medium set 2A, Ks of the medium set 3A, and Ls of the medium set 4A together compose a stripe. Pt of the medium set 1A, Jt of the medium set 2A, Kt of the medium set 3A, and Lt of the medium set 4A together compose a stripe.

An operation when the information storage medium library array apparatus 100 reproduces data near a switching between recording layers in an information storage medium in an information storage medium set shown in FIG. 23 will be described.

The array controller 101 restrains the information storage medium library device 106 from reproducing data in Pi and Lj, which are located immediately after switching of recording layers in an information storage medium in the medium set 4A in FIG. 23. In the meanwhile, from the data which are reproduced by the remaining information storage medium library devices 103 to 105 from Ji of the medium set 1A, Ki of the medium set 2A, and Li of the medium set 3A, the array controller 101 restores the data in Pi of the medium set 4A; and from the data which are reproduced by the information storage medium library devices 103 to 105 from Jj of the medium set 1A, Kj of the medium set 2A, and Pj of the medium set 3A, the array controller 101 restores the data in Lj of the medium set 4A. Herein, during the data restoration while restraining data reproduction in Pi and Lj of the medium set 4A, the information storage medium library device 106 performs switching to the recording layer to be reproduced and prepares itself to reproduce Lk, which is the subsequent region of Lj. Similarly, the array controller 101 restrains the information storage medium library devices 105, 104, and 103 from reproducing data in, respectively: Kk and Kl, which are located immediately after switching of recording layers in an information storage medium in the medium set 3A of FIG. 23; Km and Kn, which are located immediately after switching of recording layers in an information storage medium in the medium set 2A; and Jo and Pp, which are located immediately after switching of recording layers in an information storage medium in the medium set 1A. From the data which are reproduced by the remaining three of the information storage medium library devices 103 to 106 from the information storage media in the other information storage medium sets composing the same stripe, the array controller 101 restores the data whose reproduction has been restrained.

In this manner, similarly for any other switching between recording layers, the information storage medium library array apparatus 100 restrains data reproduction immediately after switching of recording layers in the information storage medium, restores data from the data which are reproduced from the information storage media in the other information storage medium sets, and, during the data restoration while restraining data reproduction, performs switching of recording layers and prepares itself to reproduce a subsequent portion to the region in which reproduction has been restrained, whereby continuous data reproduction is enabled even upon switching between recording layers, without suspending data reproduction.

In the case where the region in which data reproduction has been restrained is a parity block, data whose reproduction has been restrained does not need to be restored from data which are reproduced from the information storage media in other information storage medium sets. For example, Pi of the medium set 4A and Pp of the medium set 1A in FIG. 23 do not need to be restored.

Next, an operation when the information storage medium library array apparatus 100 reproduces data near a change of the information storage medium in an information storage medium set shown in FIG. 23 will be described.

The array controller 101 restrains the information storage medium library device 106 from reproducing data in Pq and Lr, which are located immediately after a change of the information storage medium in the medium set 4A in FIG. 23. In the meanwhile, from the data which are reproduced by the remaining information storage medium library devices 103 to 105 from Jq of the medium set 1A, Kg of the medium set 2A, and Lq of the medium set 3A, the array controller 101 restores data in Pq of the medium set 4A; and from the data which are reproduced by the information storage medium library devices 103 to 105 from Jr of the medium set LA, Kr of the medium set 2A, and Pr of the medium set 3A, the array controller 101 restores data in Lr of the medium set 4A. Herein, during the data restoration while restraining data reproduction from Pq and Lr of the medium set 4A, the information storage medium library device 106 changes the information storage medium to reproduce from in the medium set 4A, and prepares itself to reproduce Ls, which is the subsequent region of Lr. Similarly, the array controller 101 restrains the information storage medium library devices 105, 104, and 103 from reproducing data in, respectively: Ks and Kt, which are located immediately after a change of the information storage medium in the medium set 3A in FIG. 23; Ku and Kv, which are located immediately after a change of the information storage medium in the medium set 2A; and Jw and Px, which are located immediately after a change of the information storage medium in the medium set 1A. From the data which are reproduced by the remaining three of the information storage medium library devices 103 to 106 from the information storage media in the other information storage medium sets composing the same stripe, the array controller 101 restores the data whose reproduction has been restrained.

In this manner, similarly upon any other change of an information storage medium, the information storage medium library array apparatus 100 restrains data reproduction immediately after a change of the information storage medium, restores the data whose reproduction has been restrained from the data which are reproduced from the information storage media in the other information storage medium sets, and, during the data restoration while restraining data reproduction, performs changing of information storage media and prepares itself to reproduce a subsequent portion to the region whose reproduction has been restrained, whereby continuous data reproduction is enabled even when changing information storage media, without suspending data reproduction.

Thus, the information storage medium library array apparatus of the present embodiment includes a plurality of information storage medium library devices each having a recording/reproduction device, a cabinet, and a carriage. In this state, in the cabinet of each information storage medium library device, an information storage medium set combining a plurality of information storage media each having a plurality of recording layers is accommodated. Then, in each information storage medium library device, an information storage medium in the information storage medium set is carried between the cabinet and the recording/reproduction device by the carriage, and the recording/reproduction device performs data reproduction. A disk array is constituted by the information storage medium sets accommodated in the cabinets of the respective information storage medium library devices. A plurality of stripes are formed in the disk array. It has redundancy for enabling data restoration when the data in at least one information storage medium set composing a stripe cannot be reproduced. In this state, data composing one stripe is placed at physically different positions of the information storage media in the information storage medium sets. As a result of this, the information storage medium library array apparatus ensures that the timing of switching recording layers of the information storage medium and the timing of changing the information storage medium in the information storage medium set are different among the information storage medium library devices. Then, each information storage medium library device restrains data reproduction in a predetermined region range immediately after switching of recording layers in the information storage medium and a predetermined region range immediately after a change of the information storage medium in the information storage medium set. Then, the information storage medium library array apparatus restores the data in the predetermined region ranges from the data reproduced by the remaining information storage medium library devices, excluding the information storage medium library device which has been restrained from reproducing data.

With this construction, continuous data reproduction is enabled even upon switching between recording layers, without suspending data reproduction. Also, continuous data reproduction is enabled even upon changing the information storage media, without suspending data reproduction.

Moreover, while restoring the data in the predetermined region range, the information storage medium library array apparatus of the present embodiment may perform switching to the recording layer to be reproduced in the information storage medium and prepare itself to reproduce data in a subsequent region of the region in which data reproduction has been restrained, in the information storage medium library device in which data reproduction has been restrained.

Moreover, while restoring the data in the predetermined region range, the information storage medium library array apparatus of the present embodiment may change the information storage medium to be reproduced in the information storage medium set in the information storage medium library device that has been restrained from reproducing data.

In the case where the region in which data reproduction has been restrained is a parity block, data whose reproduction has been restrained does not need to be restored from data which are reproduced from the information storage media in other information storage medium sets. For example, Pq of the medium set 4A and Px of the medium set 1A in FIG. 23 do not need to be restored.

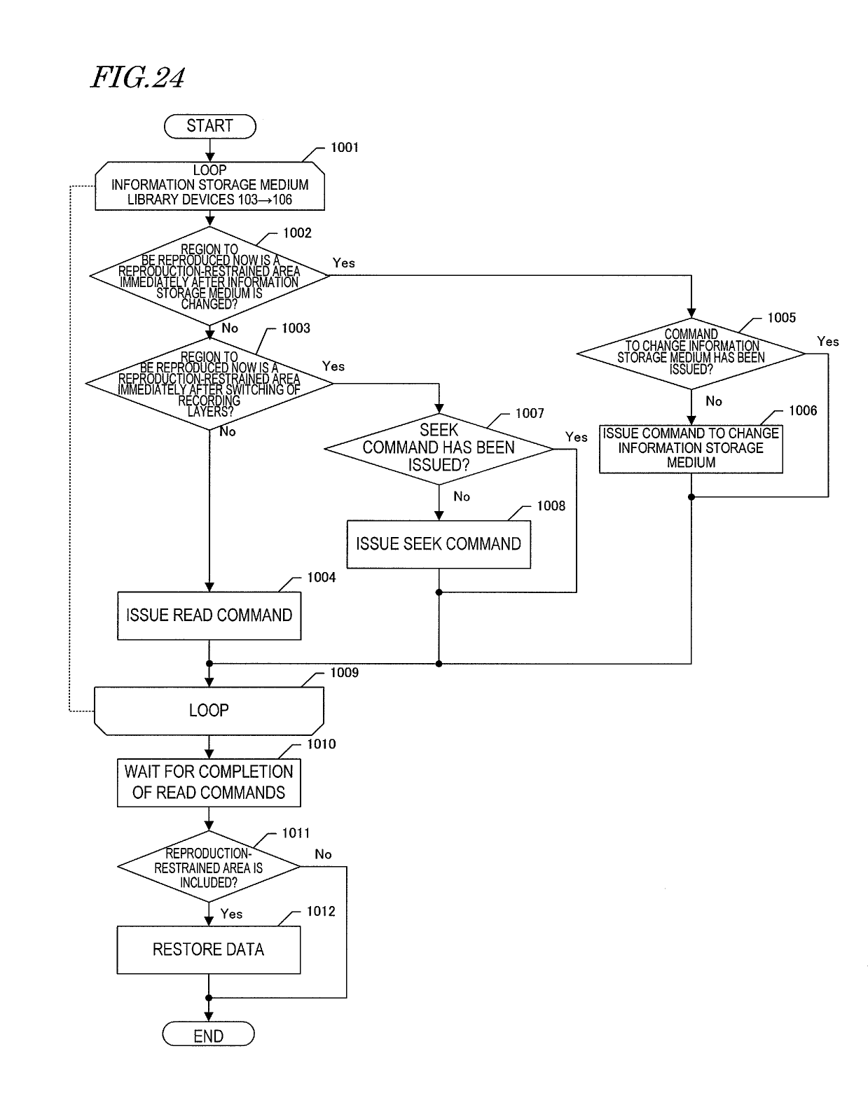

FIG. 24 is a flowchart showing a reproduction operation of the information storage medium library array apparatus 100 according to Embodiment 6.

The array controller 101 repeats the steps between step 1001 and step 1009 for each of the information storage medium library devices 103 to 106.

At step 1002, the array controller 101 determines whether the region which is going to be reproduced now is a reproduction-restrained area 211 immediately after a change of the information storage medium. If it is not a reproduction-restrained area 211, control proceeds to step 1003; if it is a reproduction-restrained area 211, control proceeds to step 1005.

At step 1003, the array controller 101 determines whether the region which is going to be reproduced now is a reproduction-restrained area 211 immediately after switching of recording layers. If it is not a reproduction-restrained area 211, control proceeds step 1004; if it is a reproduction-restrained area 211, control proceeds to step 1007.

At step 1004, the array controller 101 issues a READ command to the targeted information storage medium library device (one of 103 to 106), and proceeds to a detection of termination of repetition of steps 1001 to 1009.

At step 1005, the array controller 101 determines whether a command to change the information storage medium has already been issued for the targeted information storage medium library device (one of 103 to 106). If it has not been issued, control proceeds to step 1006; if it has been issued, control proceeds to a detection of termination of repetition of steps 1001 to 1009.

At step 1006, the array controller 101 issues a command to the targeted information storage medium library device (one of 103 to 106) to change the information storage medium, and proceeds to a detection of termination of repetition of steps 1001 to 1009. Note that, after the change, data reproduction in the reproduction-restrained area 211 is not performed.

At step 1007, the array controller 101 determines whether a SEEK command to a subsequent portion to the reproduction-restrained area 211 has already been issued for the targeted information storage medium library device (one of 103 to 106). If it has not been issued, control proceeds to step 1008; if it has been issued, control proceeds to a detection of termination of repetition of steps 1001 to 1009.

At step 1008, the array controller 101 issues a command to the targeted information storage medium library device (one of 103 to 106) to SEEK a subsequent portion to the reproduction-restrained area 211, and proceeds to a detection of termination of repetition of steps 1001 to 1009. As a result of this, data reproduction is not performed in the reproduction-restrained area 211.

When the processes for each of the information storage medium library devices 103 to 106 are completed, control proceeds to step 1010.

At step 1010, the array controller 101 waits for the completion of the READ commands having been issued at step 1004. When all READ commands issued at step 1004 are completed, control proceeds to step 1011.

At step 1011, the array controller 101 determines whether any region has had its reproduction restrained with respect to any of the information storage medium library devices 103 to 106. If any reproduction-restrained area 211 is included, control proceeds to step 1012; if no reproduction-restrained area 211 is included, the process is ended. As has been stated earlier, even when a reproduction-restrained area 211 exists, there is no need to proceed to step 1012 if it is a parity block.

At step 1012, by using the reproduced data from the other information storage medium library devices (the other three of 103 to 106), the array controller 101 restores the data in the region in which reproduction has been restrained, and the process is ended.

Through the above steps, the information storage medium library array apparatus 100 is able to restrain reproduction in regions immediately after switching of recording layers and immediately after a change of the information storage medium, and restore the data in the regions in which reproduction has been restrained by using reproduced data from the other information storage medium library devices.

Thus, in the information storage medium library array apparatus according to the reproduction control method of the present embodiment, a disk array is constituted by a plurality of information storage medium sets each combining a plurality of information storage media each having a plurality of recording layers. A plurality of stripes are formed in the disk array. It has redundancy for enabling data restoration when the data of an information storage medium in at least one information storage medium set composing a stripe cannot be reproduced. Moreover, data composing one stripe is recorded at physically different positions of the information storage media in the information storage medium sets. In this state, the reproduction control method of the present embodiment involves a step of restraining data reproduction in a predetermined region range immediately after switching of recording layers in an information storage medium, a step of restraining data reproduction in a predetermined region range immediately after a change of the information storage medium in the information storage medium set, and a step of restoring the data in the predetermined region ranges from the data which are reproduced from the remaining information storage medium sets, excluding the information storage medium set whose data reproduction has been restrained.

With this construction, continuous data reproduction is enabled even upon switching between recording layers, without suspending data reproduction. Also, continuous data reproduction is enabled even upon changing the information storage media, without suspending data reproduction.

In Embodiment 6, if the amount of time required for switching recording layers in an information storage medium and preparing to reproduce a subsequent portion to the region in which data reproduction has been restrained is shorter than the amount of time required for changing an information storage medium and preparing to reproduce a subsequent portion to the region in which data reproduction has been restrained, then the number of stripes in which to restrain data reproduction immediately after switching of recording layers in the information storage medium may be set smaller than the number of stripes in which to restrain data reproduction immediately after a change of the information storage medium. In other words, the number of stripes in which to restrain data reproduction immediately after a change of the information storage medium may be a number of stripes corresponding to the size t which was described in Embodiment 5, and the number of stripes in which to restrain data reproduction immediately after switching of recording layers in the information storage medium may be a number of stripes corresponding to a size which is smaller than the size t.

Although Embodiment 6 illustrates that unused areas 201 are provided at the leading ends of the first information storage media in the medium sets 2A to 4A, unused areas 201 may be dispersedly provided at the leading end and at the trailing end of the first information storage medium in each medium set 2A to 4A. Similarly, although it is illustrated that unused areas 201 are provided at the trailing ends of the last information storage media in the medium sets 1A to 3A, unused areas 201 may be dispersedly provided at the leading end and at the trailing end of the last information storage medium of each medium set 1A to 3A.

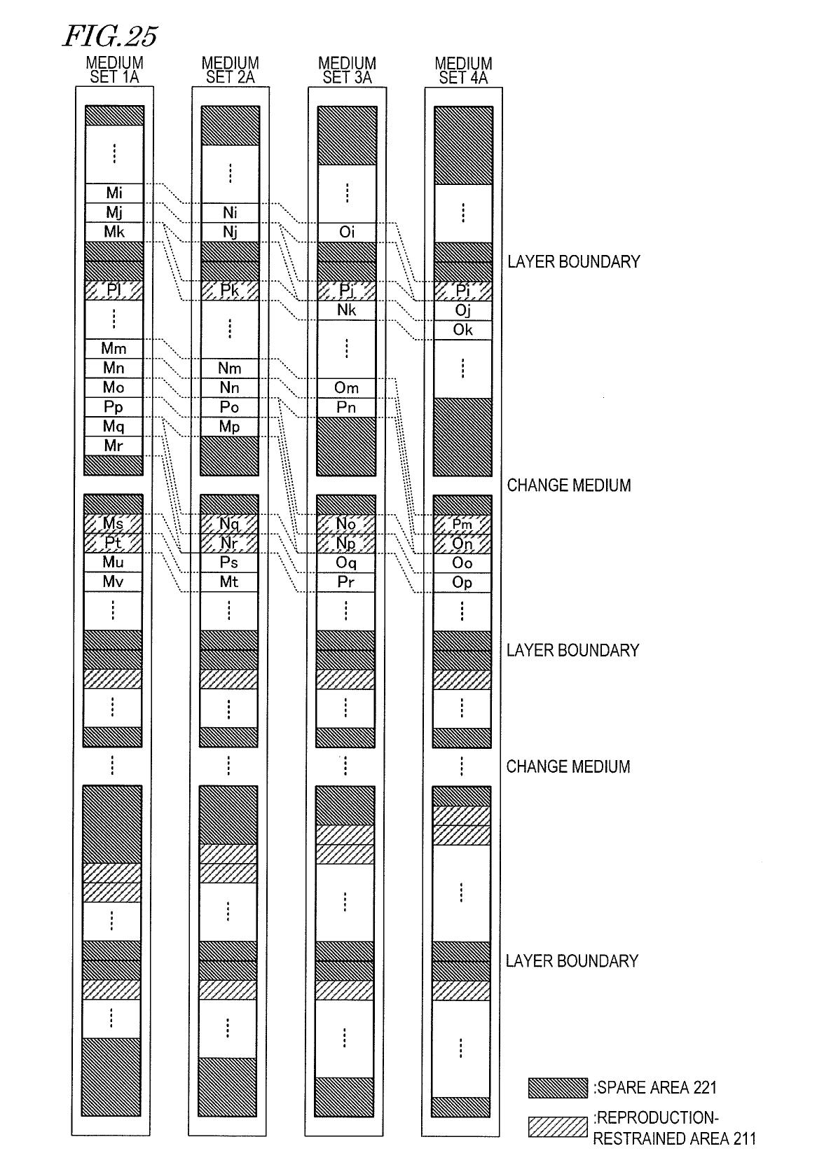

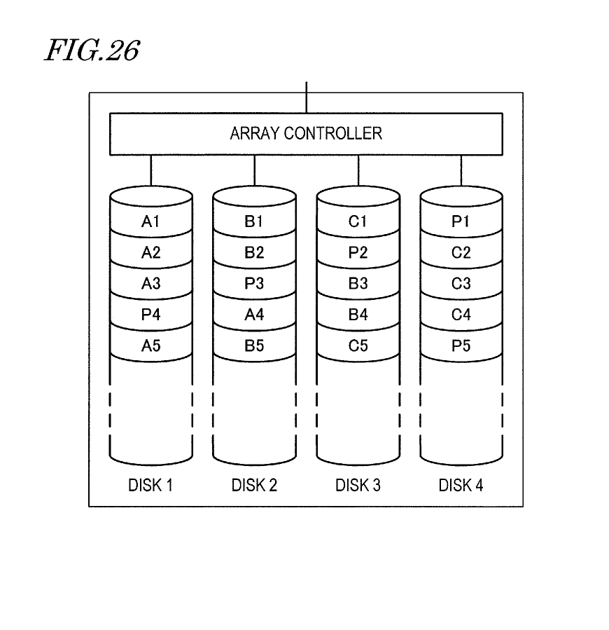

Furthermore, in the case of information storage media having spare areas 221, rather than providing unused areas 201 in the user data regions, size adjustment of the spare areas 221 may be utilized to introduce a difference of size 2u between the size of each user data region of the first information storage media in the medium sets 1A to 4A. Herein, the size 2u is a number of stripes corresponding to the size t which was described in Embodiment 5. Similarly, a difference of size 2u may be introduced between the size of each user data region of the last information storage media in the medium sets 1A to 4A. An example will be described with reference to FIG. 25. In FIG. 25, the spare areas 221 are dispersedly provided at the leading end, a layer boundary, and the trailing end of the information storage medium so that, in the first information storage media in the medium sets 1A to 4A, they have sizes of β, β+2u, β+4u, and β+6u, respectively. Herein, β is an arbitrary size. Moreover, the spare areas 221 the spare areas 221 are dispersedly provided at the leading end, a layer boundary, and the trailing end of the information storage medium so that, in the last information storage media in the medium sets 1A to 4A, they have sizes of γ+6u, γ+4u, γ+2u, and γ, respectively. Herein, γ is an arbitrary size, to which the same value as β may be set. In the remainder of the information storage media excluding the first and last in the medium sets 1A to 4A, the size of the spare areas 221 is all δ. Herein, δ is an arbitrary size, to which the same value as β or γ may be set. The blocks composing any stripe are shifted by u each in the first and last information storage media in the medium sets 1A to 4A, whereas the blocks composing any stripe are shifted by 2u each in the remainder of the information storage media. By prescribing u for the region in which to restrain data reproduction immediately after switching of recording layers, and prescribing 2u for the region in which to restrain data reproduction immediately after a change of the information storage medium, based on an implementation as described in Embodiment 6, it becomes possible to continuously reproduce data upon switching between recording layers or when changing information storage media, without suspending data reproduction.

While the above description has been directed to the case where reproduction errors are absent, the scenario under the presence of reproduction errors will additionally be described. If a reproduction error occurs in a stripe that contains a region in which to restrain reproduction near a switching of recording layers or near a change of the information storage medium, it is possible to recover from the reproduction error by exploiting stripe redundancy, through reproduction of data from the region in which reproduction has been restrained. Of course, this will result in a disruption in continuous data reproduction; therefore, it is desirable to decide whether to continue while leaving the reproduction error as it is, or take time to restore the data that is suffering from the reproduction error, depending on the attribute of the reproduced data (whether it is of a real-time attribute or not). It will be appreciated that, in the case of a stripe which does not contain any region to restrain reproduction, it is possible to recover from a reproduction error without sacrificing continuity of data reproduction, by utilizing stripe redundancy.

Reproduction operations by the information storage medium library array apparatus 100 have been described above. Now, a recording operation will be described.

In FIG. 15, the array controller 101 allows data for recording to be temporarily retained in the cache memory 102, and by requesting the information storage medium library devices 103 to 106 to record the data that is retained in the cache memory 102, causes it to be recorded on the information storage media.

In the case of recording data which requires realtimeness, generally speaking, the rate of recording data of the information storage medium library array apparatus 100 is lower than the recording rate of the information storage medium library array apparatus to information storage media at normal times. Therefore, even if switching of recording layers in an information storage medium having a plurality of recording layers or change of the information storage medium occurs during the recording of data which requires realtimeness, by providing a cache memory 102 with a sufficient capacity for retaining recording data that arrives during the time required for the switching of recording layers or the change of the information storage medium, it is possible to continuously record data without suspending the recording data for the information storage medium library device 100.

Although the above-described present embodiments illustrate scenarios under four recording/reproduction devices, similar implementation is possible with three or more recording/reproduction devices. Moreover, other than RAID5, similar implementation is also possible by adopting RAID4 or RAID6 as the RAID level to be used.

Thus, although the present invention has been illustrated with respect to specific embodiments, it would be clear to those skilled in the art that many other variants, modifications, and other usages are encompassed by the present invention. Therefore, the present invention is only to be limited by the claims, rather than being limited to the specific embodiments herein.

### INDUSTRIAL APPLICABILITY

By having a controller which assigns the same logical sector number to different physical sector numbers, the optical disk array apparatus according to the present invention is able to enhance data reliability, thereby being useful as a storage server or the like. Moreover, the present invention is applicable to archiving devices for computer systems, for example.

### REFERENCE SIGNS LIST

1, 30, 60 controller
2, 3, 31, 32, 33, 34, 61, 62, 63, 64 drive
4, 5, 36, 37, 38, 39, 66, 67, 68, 69 optical disk
6, 35, 65 optical disk array apparatus
10 lead-in zone
11 data zone
12 lead-out zone
20 inner spare area
21 data area
22 outer spare area
100 information storage medium library array apparatus
101 array controller
102 cache memory
103 to 106 information storage medium library device
107 to 110 recording/reproduction device
111 to 114 cabinet
115 to 118 carriage

1. An optical disk array apparatus having a plurality of recording/reproduction devices for performing data recording and reproduction on an optical disk, the optical disk array apparatus comprising
an assignment section for assigning a smallest logical sector number of an optical disk mounted in one of the plurality of recording/reproduction devices to a physical sector number that is different from a physical sector number to which a smallest logical sector number of an optical disk mounted in at least one of the other recording/reproduction devices is assigned,
wherein the assignment section assigns smallest logical sector numbers of the respective optical disks mounted in the plurality of recording/reproduction devices to mutually different physical sector numbers.

2. (canceled)

3. The optical disk array apparatus of claim 1, further comprising a determination section for determining stampers used for producing the respective optical disks mounted in the plurality of recording/reproduction devices, wherein
the assignment section assigns smallest logical sector numbers of optical disk sharing a same stamper to mutually different physical sector numbers.

4. The optical disk array apparatus of claim 1, wherein,
each optical disk includes a data area and a spare area; and
the assignment section assigns a respectively different size for the spare area which is at a leading end of the data area of each optical disk.

5. The optical disk array apparatus of claim 4, wherein the assignment section ensures a size assignment so that a total of a size of the spare area at the leading end of the data area and a size of the spare area at a trailing end of the data area is mutually equal among the plurality of optical disks.

6. The optical disk array apparatus of claim 1, wherein,
each optical disk includes a data area; and
in an optical disk whose smallest logical sector number is assigned to a physical sector number not corresponding to a leading end of the data area, the assignment section allows a next logical sector number to a logical sector number which is assigned to a physical sector number corresponding to a trailing end of the data area to be assigned to a physical sector number corresponding to the leading end of the data area.

7. An optical disk array apparatus for reproducing data from optical disks,
the optical disk array apparatus comprising a plurality of optical disk library devices each including a recording/reproduction device, a cabinet, and a carriage, the cabinet accommodating a plurality of optical disks, and
the optical disk being carried by the carriage between the cabinet and the recording/reproduction device for permitting data reproduction by the recording/reproduction device, wherein,
a disk array is constituted by the plurality of optical disks in the plurality of optical disk library devices;
stripes are recorded in the disk array;
the stripes have redundancy for enabling, when data fails to be reproduced in at least one of the plurality of optical disks in which data composing a same stripe is recorded, restoration of the data failing to be reproduced;
data composing a same stripe is recorded at physically different positions of the plurality of optical disks, so that mutually different timings for optical disk changing exist among the plurality of optical disk library devices;
the optical disk library device avoids reproducing data in a predetermined region range immediately after optical disk changing; and
the data in the predetermined region range is restored from data reproduced by the optical disk library devices other than the optical disk library device avoiding data reproduction in the predetermined region range.

8. The optical disk array apparatus of claim 7, wherein the optical disk library device avoiding data reproduction in the predetermined region range performs the optical disk changing while restoring the data.

9. The optical disk array apparatus of claim 7, wherein,
each of the plurality of optical disks has a plurality of recording layers;
data composing a same stripe is recorded at physically different positions of the plurality of optical disks, so that mutually different timings for recording layer switching exist among the plurality of optical disk library devices;
the optical disk library device avoids reproducing data in a predetermined region range immediately after recording layer switching; and
the data in the predetermined region range immediately after recording layer switching is restored from data reproduced by the optical disk library devices other than the optical disk library device avoiding data reproduction in the predetermined region range immediately after recording layer switching.

10. The optical disk array apparatus of claim 9, wherein, while the data is being restored, the optical disk library device avoiding data reproduction in the predetermined region range immediately after recording layer switching switches recording layers and prepares itself to reproduce data in a subsequent region of the predetermined region range.

11. The optical disk array apparatus of claim 7, wherein,
the optical disks have a leading spare area and a trailing spare area; and
data composing a same stripe is recorded at physically different positions of the plurality of optical disks by varying a ratio between sizes of the leading spare area and the trailing spare area among the plurality of optical disks constituting the disk array.

12. A reproduction method for reproducing data from a disk array composed of a plurality of optical disks, wherein,
stripes are recorded in the disk array;
the stripes have redundancy for enabling, when data fails to be reproduced in at least one of the plurality of optical disks in which data composing a same stripe is recorded, restoration of the data failing to be reproduced;
data composing a same stripe is recorded at physically different positions of the plurality of optical disks; and
each optical disk composing the disk array is changeable to another optical disk,
the reproduction method comprising:
a step of avoiding data reproduction in a predetermined region range immediately after optical disk changing; and
a step of restoring the data in the predetermined region range from data which is reproduced from the remaining optical disks composing the disk array excluding an optical disk in which data reproduction in the predetermined region range is avoided.
